(19) United States
(12) Patent Application Publication
(10) Pub. No.: US 2022/0258676 A1
(43) Pub. Date: Aug. 18, 2022

(54) VACUUM MOUNTED CARRIER FOR A VEHICLE

(71) Applicant: SEASUCKER, LLC, Bradenton, FL (US)

(72) Inventor: Charles L. CASAGRANDE, Bradenton, FL (US)

(21) Appl. No.: 17/736,405

(22) Filed: May 4, 2022

Related U.S. Application Data
(63) Continuation-in-part of application No. PCT/US2020/058981, filed on Nov. 4, 2020.
(60) Provisional application No. 62/930,416, filed on Nov. 4, 2019.
(60) Provisional application No. 62/930,365, filed on Nov. 4, 2019.

(51) Int. Cl. B60R 9/12

(52) U.S. Cl. CPC B60R 9/12

(57) ABSTRACT

A support rack is constructed where a first support rack and a second support rack can be used in combination with the first support rack and the second support rack releasably attached to items such as ski equipment to secure the items to the support racks, and then the first support racks can be releasably attached to a separate surface to secure the items to the separate surface. Each support rack includes a mounting board having notches or slots that are used in releasably attaching items to the mounting boards. Each support rack also includes a clamp that is removably attachable to the mounting board to secure the items to the mounting board.

### RELATED APPLICATIONS

This application is a continuation-in-part of PCT Patent Application PCT/US2020/058981 which claims priority to U.S. Provisional App. No. 62/930,365 filed Nov. 4, 2019 and U.S. Provisional App. No. 62/930,416 file Nov. 4, 2019, all of which are incorporated herein by reference.

### STATEMENT REGARDING FEDERALLY SPONSORED RESEARCH

Not Applicable.

### BACKGROUND

The present disclosure relates to collapsible racks or carrier systems (hereinafter referred to as a “rack”) that detachably installs on automotive vehicles for securely transporting various articles, including without exception, ski and/or snowboard equipment, without compromising, but instead maintaining, the integrity of the mounting surface, and more particularly, to collapsible surface mount equipment rack systems that detachably install on automotive vehicles with a vacuum assembly for transporting such articles.

Carriers or racks are commonly used with automotive vehicles to transport various recreational equipment, such as, bicycles, skis, snowboards, surfboards, and the like. Conventional racks are mounted in one of these locations: to the roof, to the trunk, the rear window frame, to the truck bed, or to a trailer hitch. In order to withstand the large forces exerted on the rack and the rack's supported articles while the vehicle is moving, such racks must securely attach to the vehicle. Conventional racks are permanently attached to the vehicle body or frame with fasteners, or removably attached to the vehicle's body or frame using brackets, straps, or latches. However, these methods have disadvantages.

Conventional permanently installed racks can be expensive to purchase and install, and typically require modifications to the vehicle. In addition, they either cannot be removed, or if they can be removed, such removal is very difficult and can result in residual damage to the vehicle. Conventional detachable racks are difficult and time-consuming to install and must be repeatedly installed and removed. Also, they are susceptible to damaging the vehicle during installation and use due to the plates and straps applied to the vehicle under tension which causes denting and scratching. If improperly installed, damage can occur to the vehicle and the articles being transported. Such conventional racks are not designed for releasable attachment to the vehicle windows or the surfaces of the vehicle, but instead must be attached to other parts of the vehicle. Moreover, in order to provide sufficient span and girth, along with sufficient rigidity, conventional racks are necessarily large and cumbersome, and therefore not readily transportable or storable away from the vehicle to which they are mounted.

Further, conventional racks are typically designed for use with a specific make and model of vehicle. Therefore, they generally do not work on different vehicles, at least not without adaptors or modifications. As a result, conventional rack manufacturers must produce an increased number of parts and retailers must provide and/or inventory an ever increasingly complex list of parts and options lists to consumers, which also increases the cost. In addition, consumers that purchase a conventional rack for one vehicle may not be able to use the same conventional rack for a different vehicle.

Therefore, there exists a need for a vehicle rack that is easily, reliably, and interchangeably installed on and removed from one or more vehicles as needed, where the rack substantially maintains the integrity of the mounting surface. Further, there exists a need for such a rack that is readily transportable and storable.

### BRIEF SUMMARY OF THE INVENTION

Applicant has developed equipment carriers or racks for releasable attachment to a vehicle can be readily assembled and disassembled such that they are collapsible, and have unique structural configurations, so as to overcome various utility issues of the type discussed herein that plague traditional carriers and racks.

### DESCRIPTION OF THE DRAWINGS

In the accompanying drawings which form part of the specification:

FIG. 1 is a perspective view of a representative embodiment of an unassembled ski rack comprising one or more features of the present disclosure;

FIG. 2 is a perspective view of a mount of the ski rack of FIG. 1;

FIG. 3 is a plan view of the mount of FIG. 2;

FIG. 4 is a top view of the first mount of FIG. 2;

FIG. 5 is a perspective view of both mounting boards for the ski rack of FIG. 1;

FIG. 6 is a perspective view of a representative snap-in strap of the ski rack of FIG. 1;

FIG. 7 is a perspective view of a representative ball strap of the ski rack of FIG. 1;

FIG. 8 is a perspective view of the ski rack of FIG. 1 mounted to the rear window of a vehicle and having a snowboard, a set of skis and a pair of ski poles secured to the ski rack;

FIG. 9 is an alternate perspective view of FIG. 8;

FIG. 10 is an alternate perspective view of FIG. 8;

FIG. 11 is an alternate perspective view of FIG. 8;

FIG. 12 is an alternate perspective view of FIG. 8;

FIG. 13 is a perspective view of a ball strap in a first configuration with one end looped through a portion of a representative mounting board;

FIG. 14 is a perspective view of the ball strap of FIG. 13 in a second configuration with one end knotted to the representative mounting board;

FIG. 15 is a perspective view of a pair of ball straps secured to a representative mounting board;

FIG. 16 is a perspective view of a ball strap securing a snowboard to a representative mounting board;

FIG. 17 is a perspective view of a second representative embodiment of an assembled ski rack comprising one or more features of the present disclosure;

FIG. 18 is a perspective view of the mounting boards with attached clamping sleeves of the ski rack of FIG. 17;

FIG. 19 is a plan view of a second representative mounting board;

FIG. 20 is a plan view of a third representative mounting board;

FIG. 21 is a plan view of a fourth representative mounting board;

FIG. 22 is a plan view of a fifth representative mounting board;

FIG. 23 is a plan view of a sixth representative mounting board;

FIG. 24 is a perspective view of a representative embodiment of an assembled cargo carrier comprising one or more features of the present disclosure;

FIG. 25 is a top view of the cargo carrier of FIG. 24;

FIG. 26 is a front plan view of the cargo carrier of FIG. 24;

FIG. 27 is a perspective view of a representative releasable bar clamp for use with various alternate configurations of the present disclosure;

FIG. 28 is a side view of the representative releasable bar clamp of FIG. 27;

FIG. 29 is a top view of the representative releasable bar clamp of FIG. 27;

FIG. 30 is a perspective view of a second representative embodiment of an assembled cargo carrier comprising one or more features of the present disclosure;

FIG. 31 is a perspective view of a third representative embodiment of an assembled cargo carrier comprising one or more features of the present disclosure;

FIG. 32 is a perspective view of a fourth representative embodiment of an assembled cargo carrier comprising one or more features of the present disclosure;

FIG. 33 is a top view of the cargo carrier of FIG. 32;

FIG. 34 is a front view of the cargo carrier of FIG. 32;

FIG. 35 is a perspective view of a fifth representative embodiment of an assembled cargo carrier comprising one or more features of the present disclosure;

FIG. 36 is a perspective view of a sixth representative embodiment of an assembled cargo carrier comprising one or more features of the present disclosure;

FIG. 37 is a top view of the cargo carrier of FIG. 36;

FIG. 38 is a front view of the cargo carrier of FIG. 36;

FIG. 39 is a perspective view of a seventh representative embodiment of an assembled cargo carrier comprising one or more features of the present disclosure;

FIG. 40 is a top view of the cargo carrier of FIG. 39;

FIG. 41 is a front view of the cargo carrier of FIG. 39;

FIG. 42 is a perspective view of an eighth representative embodiment of an assembled cargo carrier comprising one or more features of the present disclosure;

FIG. 43 is a top view of the cargo carrier of FIG. 42;

FIG. 44 is a front view of the cargo carrier of FIG. 42;

FIG. 45 is a perspective view of a ninth representative embodiment of an assembled cargo carrier comprising one or more features of the present disclosure;

FIG. 46 is a perspective view of a tenth representative embodiment of an assembled cargo carrier comprising one or more features of the present disclosure;

FIG. 47 is a top view of the cargo carrier of FIG. 46;

FIG. 48 is a side view of the cargo carrier of FIG. 46;

FIG. 49 is front view of the cargo carrier of FIG. 46;

FIG. 50 is a bottom view of the cargo carrier of FIG. 46.

FIG. 51 is a perspective view of a further representative embodiment of a support rack.

FIG. 52 is a perspective view of two support racks of FIG. 51 with a cross support item of ski equipment releasably attached to the support racks.

FIG. 53 is a perspective view of the support rack of FIG. 51 with a cross section view of a clamp of the support rack removed from a mounting board of the support rack.

Corresponding reference numerals indicate corresponding parts throughout the several figures of the drawings.

### DETAILED DESCRIPTION

The following detailed description illustrates the claimed invention by way of example and not by way of limitation. The description enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

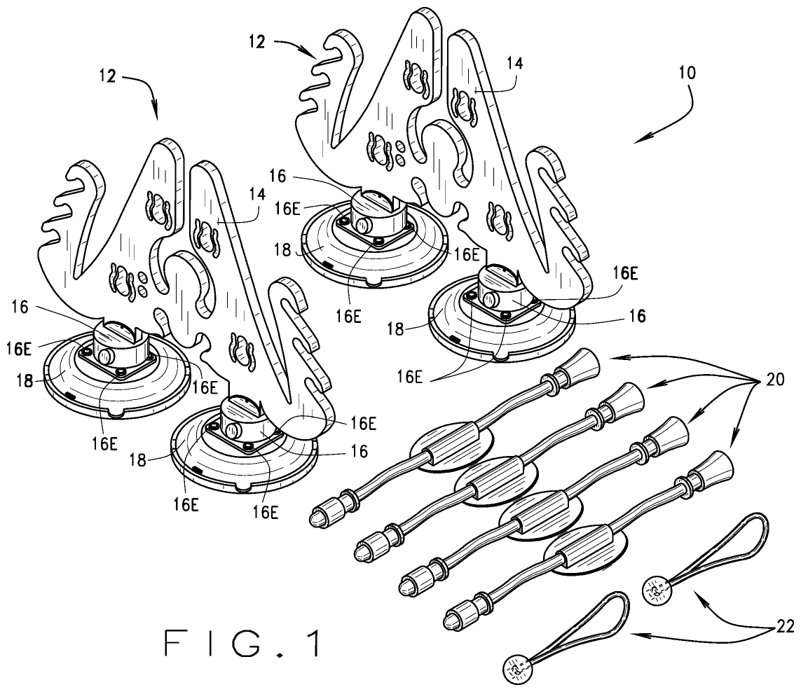

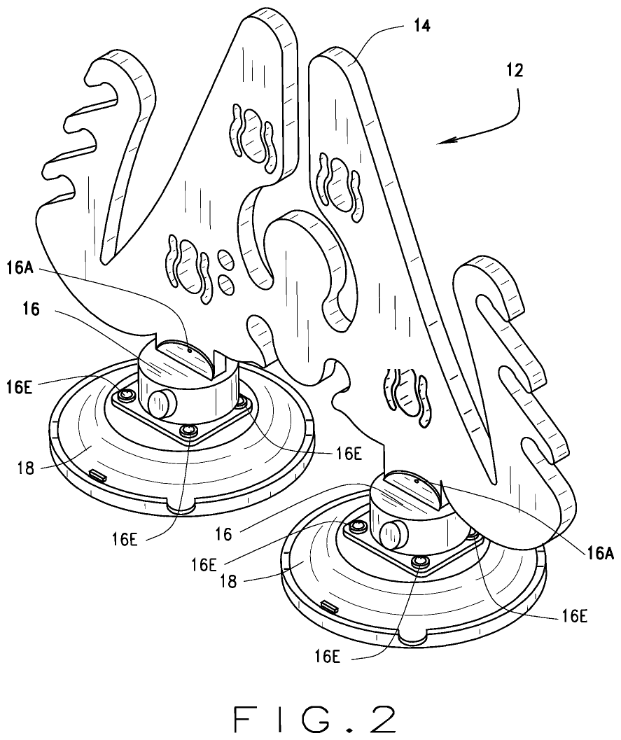

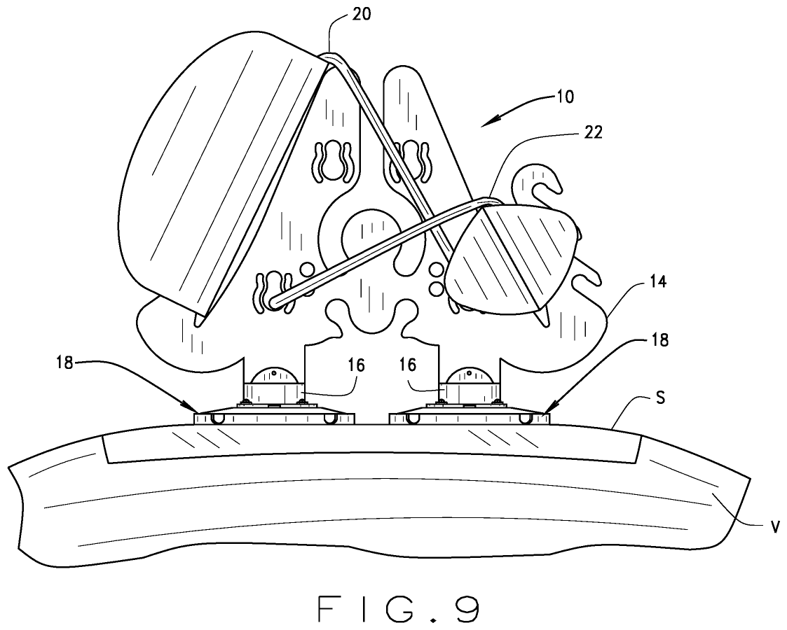

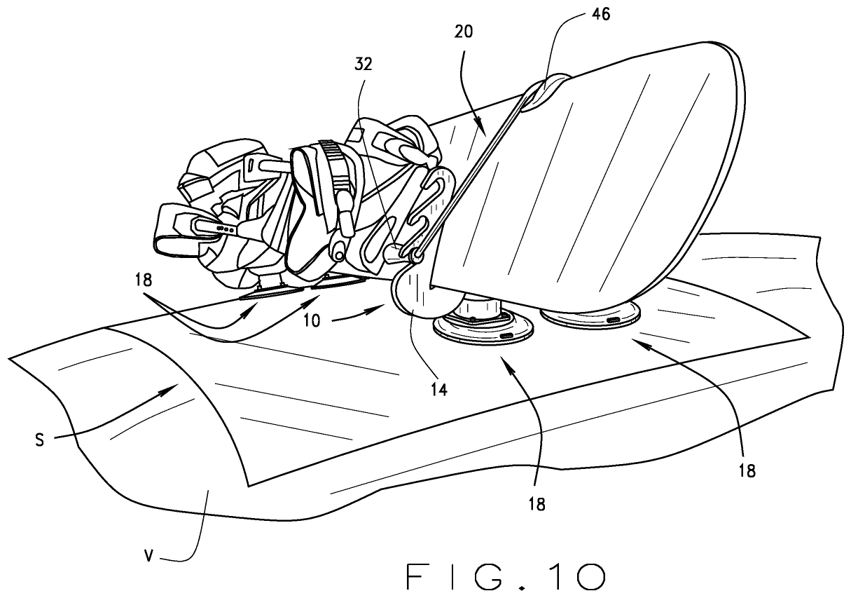

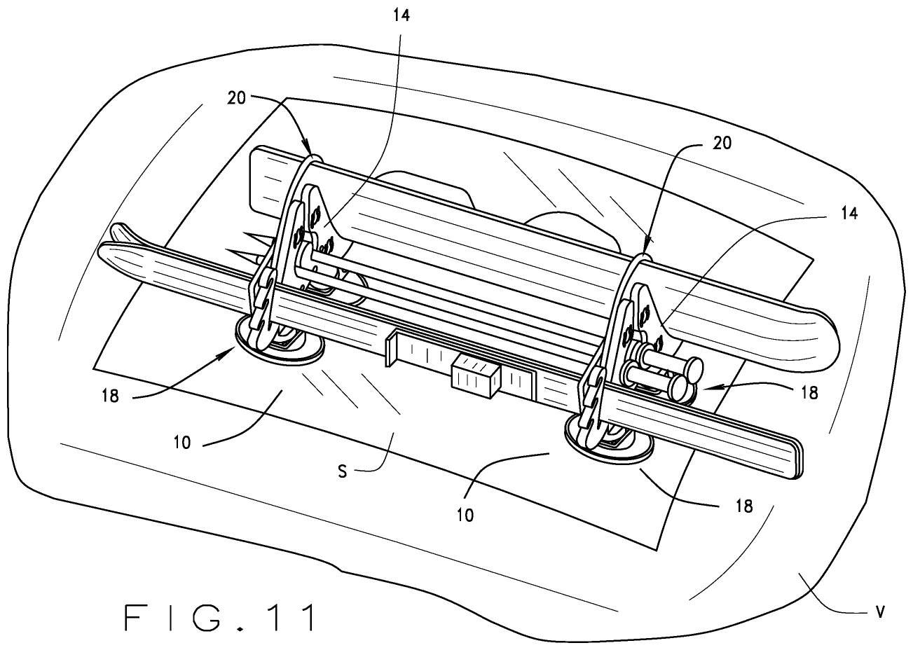

As can be seen in FIGS. 1-16, a first representative embodiment of the present disclosure, generally referred to as a ski rack 10, includes two identical mounts 12, each mount 12 having a flat and rigid mounting board 14 formed of compressed board (or other such similarly rigid and workable material, such as for example, plywood, rigid plastic, light weight metals such as aluminum, and carbon fiber) approximately one half inch thick, a pair of vertically oriented releasable fasteners 16 attached to the bottom of the mounting board 14, and two vacuum devices 18 that can detachably attach to a mounting surface S of a vehicle. Each of the fasteners 16 houses a push-button pump that manually generates the vacuum for its respective vacuum device 18. Each of the vacuum devices 18 attaches with four screws 16E to the bottom of one of the fasteners 16 attached to its respective mounting board 14. The ski mount 10 further includes a set of four elastic “bungee” snap-in straps 20 and two elastic “bungee” ball straps 22 (see, particularly, FIG. 1). Of course, the ski rack 10 need not have exactly four snap-in straps 20 and two ball straps 22, but may instead comprise differing numbers of each, and may even have none.

The vacuum devices 18, their capabilities and operation have been disclosed and explained in various previous disclosures by the applicant in association with a variety of rack and carrier configurations, including for example International Application WO 2018/227203, pending Application No. PCT/US2018/036951, filed on Jun. 11, 2018, prior application Ser. No. 13/497,653 and issued U.S. Pat. No. 9,821,721, and each is hereby fully incorporated herein by reference as though expressly set forth herein.

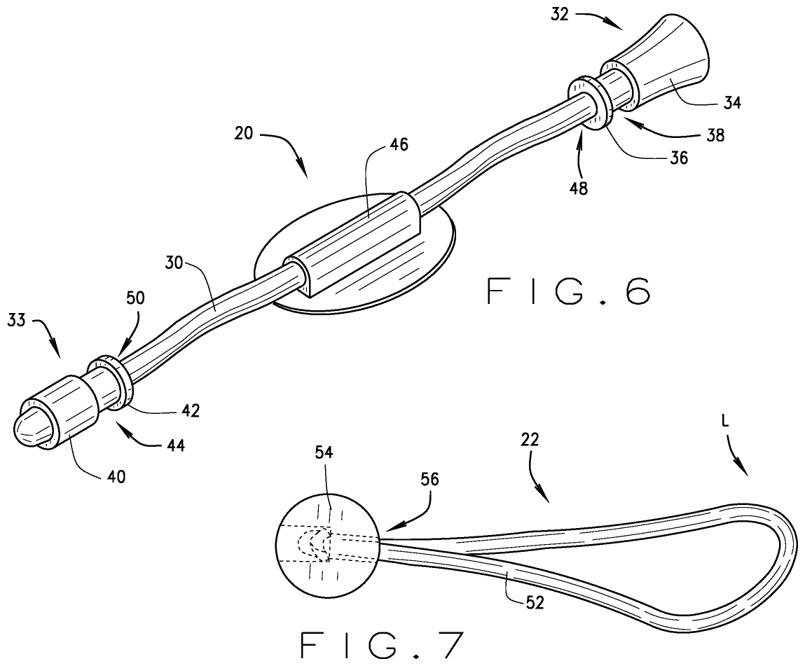

Referring to FIG. 6, it can be seen that each of the snap-in straps 20 has a central “bungee” cord 30 of approximately 18 inches in length that spans between a slightly pliant, hollow and first generally radial handle 32 at one end and a second generally radial handle 33 at the opposite end. Of course, the length of the cord 30 is not limited to 18 inches, but may be various lengths, such as for example 6, 12 or 24 inches, so long as cord 30 enables the strap 20 to perform its desired function as described herein. The handle 32 has a frustoconical outer grip portion 34 and a thinner cylindrical inner washer portion 36. A narrow, depressed radial groove 38 separates the grip portion 34 from the washer portion 36. The handle 33 has a slightly pliant, elongated square-shaped outer grip portion 40 and a thinner cylindrical inner washer portion 42. A narrow, depressed radial groove 44 separates the grip portion 40 from the washer portion 42. A generally flat and oval shaped pad 46 is attached to the center of the cord 30. The pad 46 is constructed of a durable yet pliant textile covering a core formed of an elastic yet durable material such as for example, neoprene foam. Each end of the cord 30 is secured to one of the handles 32 or 33 by entering an axial hole 48 in the washer portion 36, or through a similar axial hole 50 in the washer portion 42, and forming a knot in the cord end inside the respective handle, the knot being too large to pull through the axial holes 48 or 50.

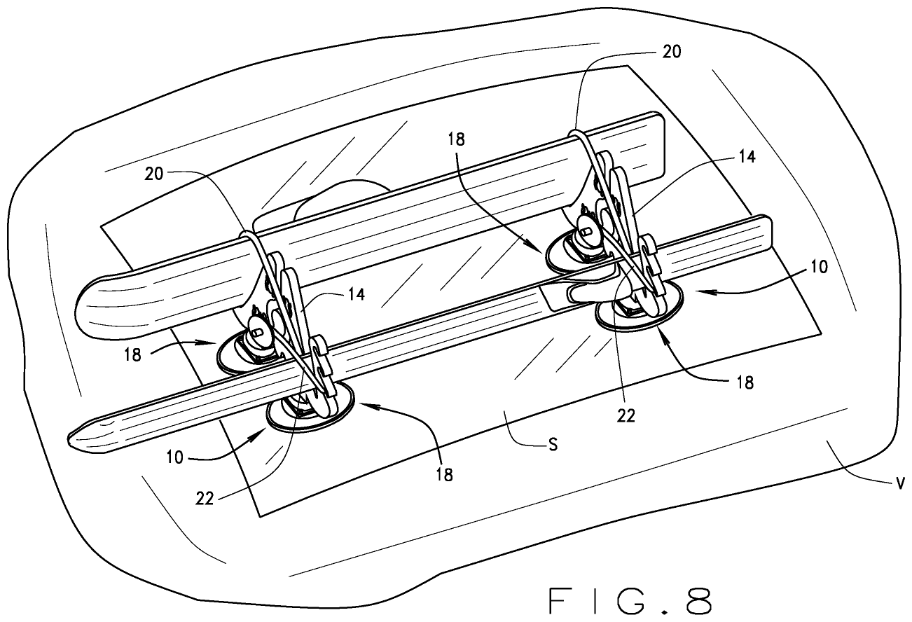

Similarly, and referring now to FIG. 7, each of the ball straps 22 has a “bungee” cord 52 of approximately 18 inches in length, and a hollow ball 54 with a bore 56 there through opening into the hollow body of the ball 54. The bore 56 has a narrow portion and a wide portion. Of course, the length of the cord 52 is not limited to 18 inches, but may be various lengths, such as for example 6, 12 or 24 inches, so long as cord 52 enables the strap 22 to perform its desired function as described herein. The narrow and wide portions of the bore 56 are both sized to allow the simultaneous passage of both ends of the cord 52. However, when the cord 52 is formed into a loop L, both ends are passed through the bore 56 in into the hollow body of the ball 54, and the ends of the cord 52 are tied together in a knot, the ends of the cord 52 cannot pass through the narrow portion of the bore 56.

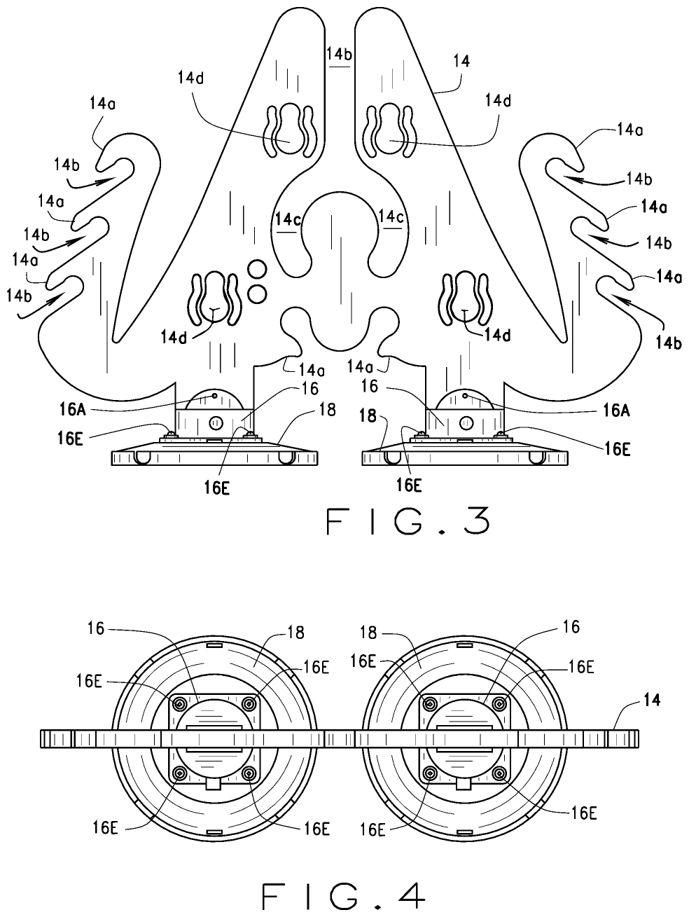

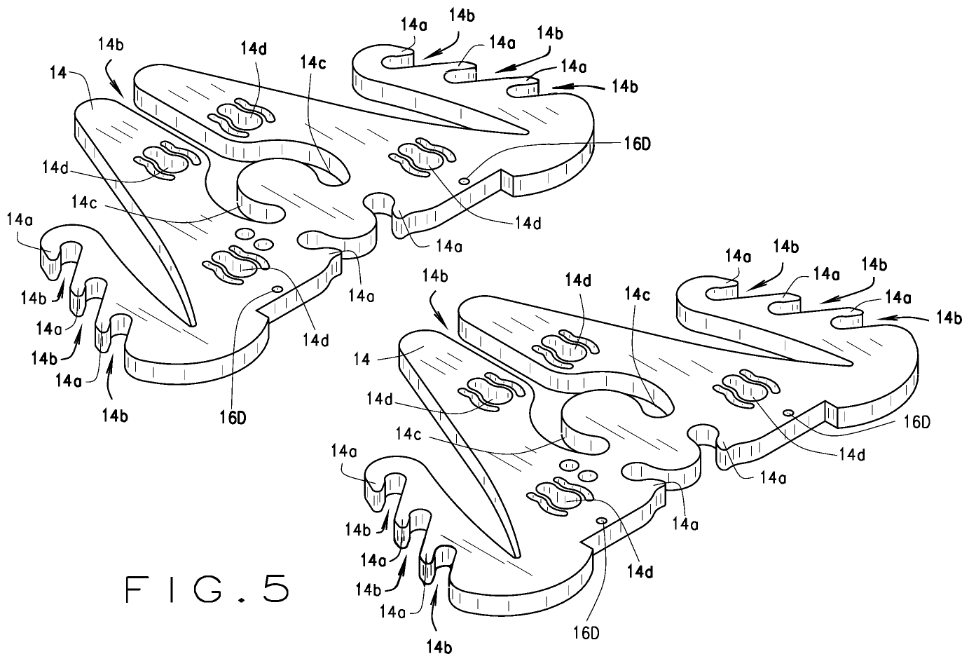

Referring now to FIGS. 3 and 5, it can be seen that each of the mounting boards 14 is formed or cut with a number of arms 14a, open ended slots 14b, open ended curved slots 14c, and keyholes 14d. As can be readily understood by a user or by one of ordinary skill in the art, each of these attachment features provides a particular structure on which to secure a snap-in strap 20 or a ball strap 22. That is, each of these attachment features is sized and shaped to allow for the placement of at least one or more snap-in straps 20 or ball straps 22 over or through such attachment feature so that the cords 30 and 52 can be wrapped around an item placed upon the mounting board 14 to secure it to the ski rack 10. Generally, each such slot is shaped and sized such that the cords 20 and 22 can readily fit through the slot, while the pad 46 and the ball 54 cannot. This allows the cord 20 or 22 to be stretched from the mounting board 14 to wrap in tension around a piece of ski equipment, such as a ski or a ski pole, which is thus held in place and secured to the mounting board 14.

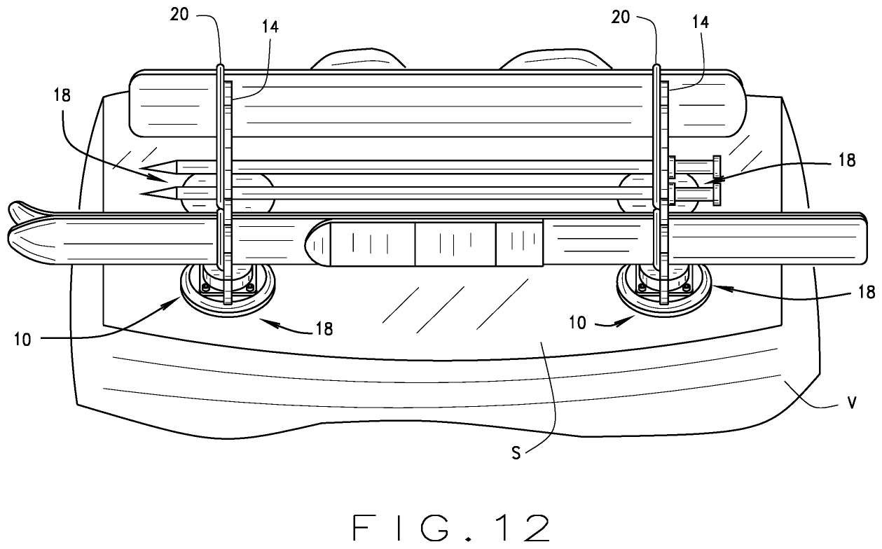

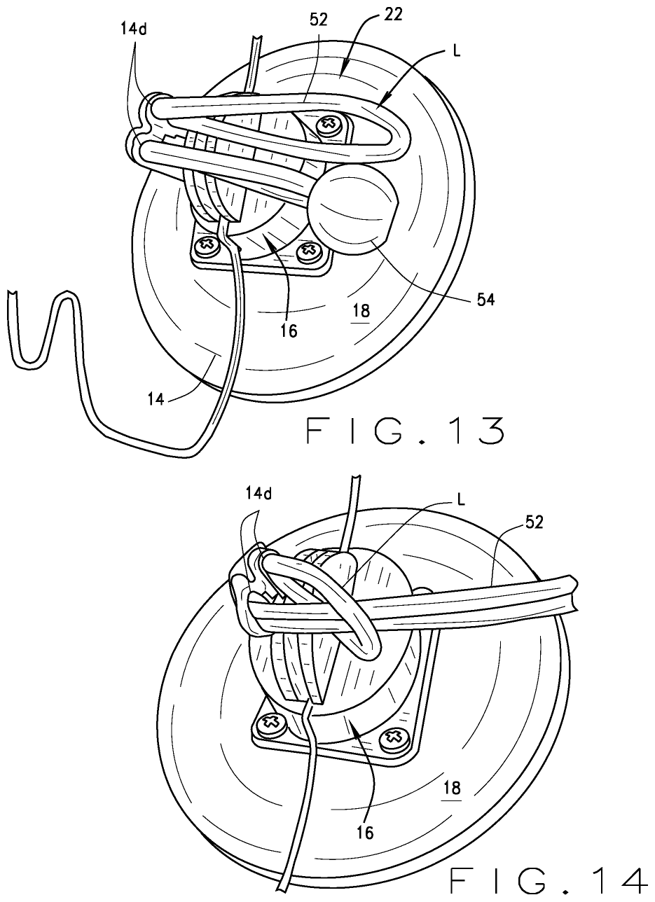

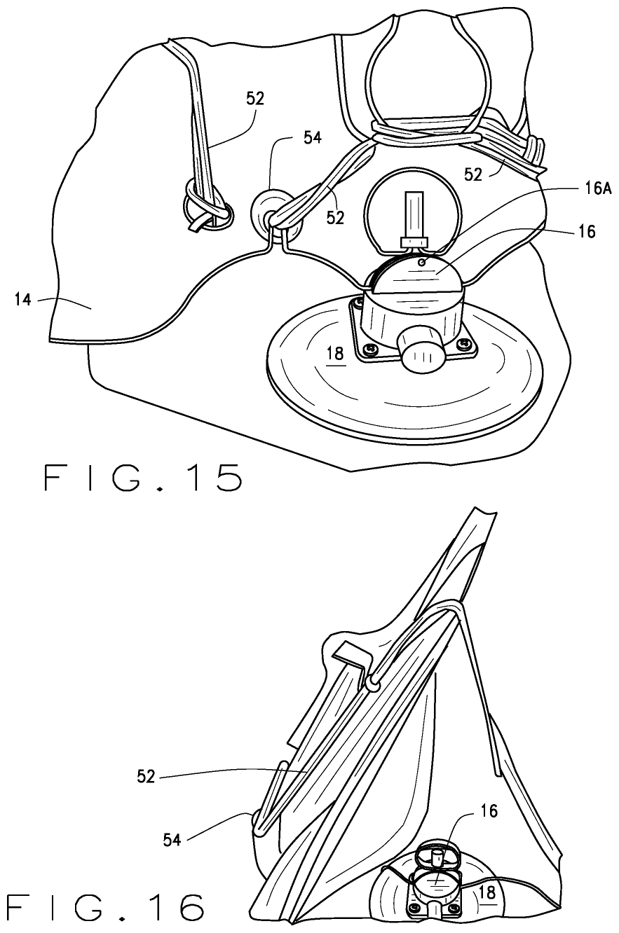

In this regard, FIG. 13 depicts a ball strap 22 threaded through two openings in a representative mounting board B. As can be seen, the loop L is threaded through a first opening of one of the keyholes 14d and then threaded back through a second opening of the same keyhole 14d such that the loop L and the ball 54 are on the same side of the mounting board B. In FIG. 14 it can be seen that the ball 54 can then be pulled through the loop L to stretch the cord 52 and pull the loop L tight against the mounting board B. This secures the loop L to the mounting board B such that he cord 52 with the ball 54 can be stretched away from the mounting board B to secure an item to the board. This is further depicted in FIG. 15, which shows how the cord 52 on a ball strap 22 can be stretched over an item placed on the mounting board B. The cord 52 can then be stretched through one of the attachment features on the mounting board B and released to allow the ball 54 to pull against the mounting board B and hold the ball strap 22 in place under the tension in the cord 52.

The snap-in straps 20 can be used in a similar fashion. However, the radial grooves 38 and 44, of the handles 32 and 33, are both sized and shaped to snugly fit into—that is, “snap” into”—various of the attachment structures or features, e.g., 14b and 14d, formed in each mounting board 14. This “snap-in” attribute provides for a more rapid and certain attachment of the snap-in straps 20 to the mounting boards 14.

Further, mounting boards 14 of the ski rack 10 are configured to be adaptable to simultaneously secure differing shapes and sizes of multiple items to the ski rack 10 in a variety of ways. That is, each of the snap-in straps 20 and ball straps 22 can provide secure attachment of an item to the mounting board 14. The ski rack 10 can therefore couple with a variety of recreational articles, including, but not limited to, skis, ski poles, snowboards, surfboards, fishing rods, and hiking poles and sticks. An example of the many ways in which various items can be secured to a ski rack 10 is shown in FIGS. 8-12, where a ski rack 10 is mounted to a rear window of a vehicle V, and a snowboard, a pair of skis and a pair of ski poles are all secured to the ski rack 10.

As can be readily understood, the ski rack 10 can be easily disassembled into component parts and re-assembled from its various component parts and mounted to any generally flat surface of a vehicle, such as for example the rear window of the vehicle V as shown in FIGS. 8-12. As can be appreciated, in its disassembled form, the ski rack 10 presents a very compact collection of components, having only two mounting boards 14, four fasteners 16, four vacuum devices 18 and the straps 20 and 22. Collectively, these components can be easily managed, condense into a small and flat collection of components, and are therefore easily storable and transportable.

In order to assemble the ski rack 10, two of the fasteners 16 are releasably secured along their upper ends to the bottom of each of the mounting boards 14 such that the clamps each face downward away from their respective mounting boards 14. Each of the fasteners 16 is secured to its respective mounting board 14 using a removable pin 16A that extends through hole 16B in one of the upper tabs of the fastener 16, through a pre-formed corresponding orifice 16C near the bottom of the mounting board 14, and through a corresponding orifice 16D in the opposite upper tab of the fastener 16. Of course, the fasteners 16 and mounting boards 14 can be collectively configured in a number of other ways so as to enable the attachment of each fastener 16 to a mounting board 14 by a variety of other attachment means, such as for example, a quick-release clamp, a wing-nut bolt, a latch and a releasable cable tie.

The lower end of each of the fasteners 16 is then secured to the top of a vacuum device 18 by a set of four screws 16E. Each assembled set of a mounting board 14, along with its corresponding fasteners 16 and matching vacuum devices 18, forms an assembled mount 12. In the embodiment of ski rack 10, each mounting board 14 mates with two vacuum devices 18, to provide enough vacuum strength to withstand the tensions, shear, and other forces on the carrier system 10 during operation. Multiple vacuum devices 18 help stabilize the load and provide redundancy should one or more vacuum device 18 fail. Of course, the mounting boards 14 need not be limited to a specific number of vacuum devices 18 each, but can instead be configured to mate with more or less than two vacuum devices 18.

A pair of mounts 12 collectively form a ski rack 10. Each of the mounts 12 can be releasably, yet securely, mounted to a flat surface S on a vehicle V. In the FIGS. 8-12, the flat surface S is the rear window of the vehicle V as shown. The mounts 12 are positioned with their respective mounting boards 14 generally parallel one another. The distance between the mounts 12 on the surface S is not specific, but can vary depending on a number of variables, including for example, the width of the surface S and the length of the items to be secured to the ski rack 10. The ski rack 10 is thereby adaptable to varying surfaces sizes and the sizes of the items to be secured to the rack 10.

As is evident, the ski rack 10 has no cross-braces that extend between the two mounts 12. This is intentional and part of Applicant's design. First, Applicant's design contemplates that the strength of the grip of the vacuum devices 18 to the surface S of a vehicle V, along with the structural rigidity of the mounting boards 14, collectively provide substantial stability and structural strength to the ski rack 10. Yet, as can be appreciated by one of ordinary skill in the art, when the ski rack 10 is mounted to a surface S of a vehicle V, and one or more elongated rigid pieces of equipment or other devices, such as for example skis, ski poles and snow boards, extend between and are secured to both mounts 12, such equipment linked to and thereby working in conjunction with the mounting boards 14, collectively act as integrated structural cross-members that further stabilize the ski rack 10 during use.

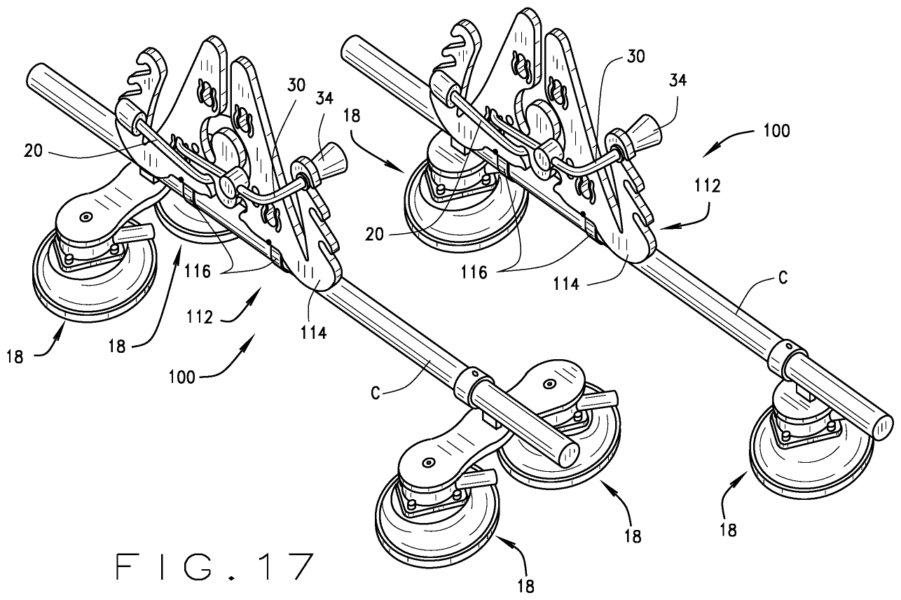

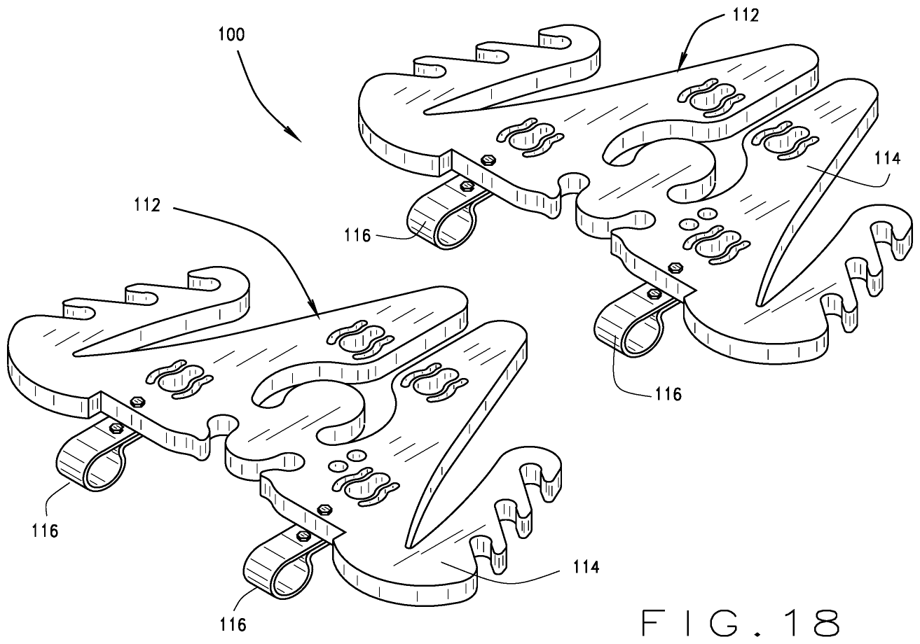

Referring now to FIGS. 17 and 18, an alternate embodiment of the present disclosure is depicted, generally referred to as a ski rack 100. The ski rack 100 includes two identical mounts 112, each mount 112 having a flat and rigid mounting board 114 formed of compressed board (or other such similarly rigid and workable material, such as for example, plywood, rigid plastic, light weight metals such as aluminum, and carbon fiber) approximately one half inch thick. Each mounting board 114 has attached to its lower edge a pair of horizontally aligned releasable tube clamps 116. The tube clamps 116 are shaped and sized to releasably attach to the cross support tubes C of a vehicle vacuum mount previously presented by the Applicant, which can be seen, for example, in International Application WO 2018/227203. Each pair of tube clamps 116 is positioned and oriented in their attachment to the mounting boards 114 so as to position the mounting board 114 parallel to the tube C when so attached. (See FIG. 17). The mounting boards 114 are otherwise substantially the same as the mounting boards 14.

Like the ski rack 10, the ski rack 100 further includes a set of elastic “bungee” snap-in straps 20 and elastic “bungee” ball straps 22. Of course, the ski rack 100 need not have any specific number of snap-in straps 20 or ball straps 22, but may instead comprise differing numbers of each, and may even have none of one or the other. It should be noted that the mounting boards 14 of the ski rack 10 and the mounting boards 114 of the ski rack 100 are designed to be readily interchangeable, and can even be identical.

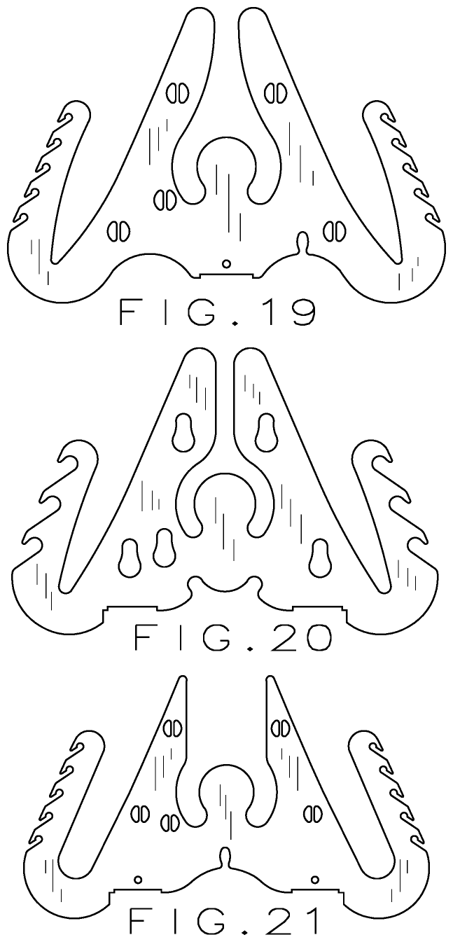

FIGS. 19-23 depict various alternate embodiments of the mounting boards 14 and 114 of the ski racks 10 and 100, respectively. As can be seen from these figures and FIGS. 1-18, and as would be readily understood by one of ordinary skill in the art, each of the alternate mounting boards in FIGS. 19-23 is capable of attachment to one or more vacuum devices 18 by attachment to a corresponding fastener 16 at the lower end of the depicted mounting board.

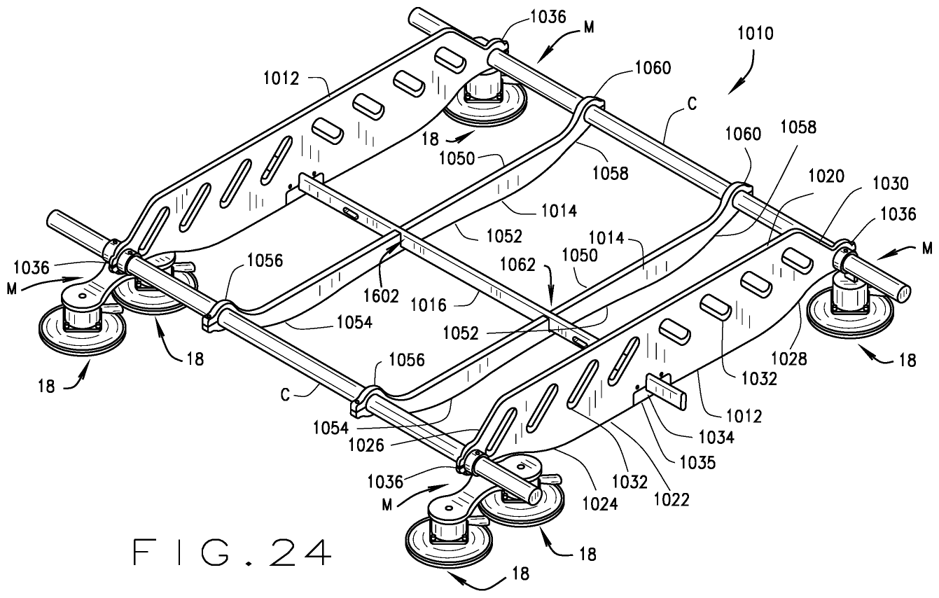

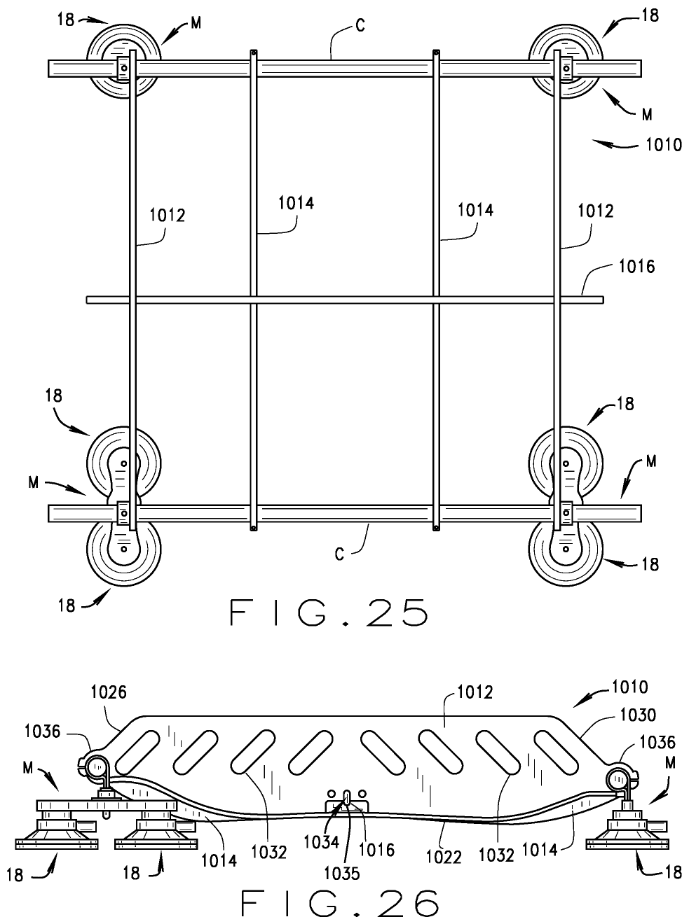

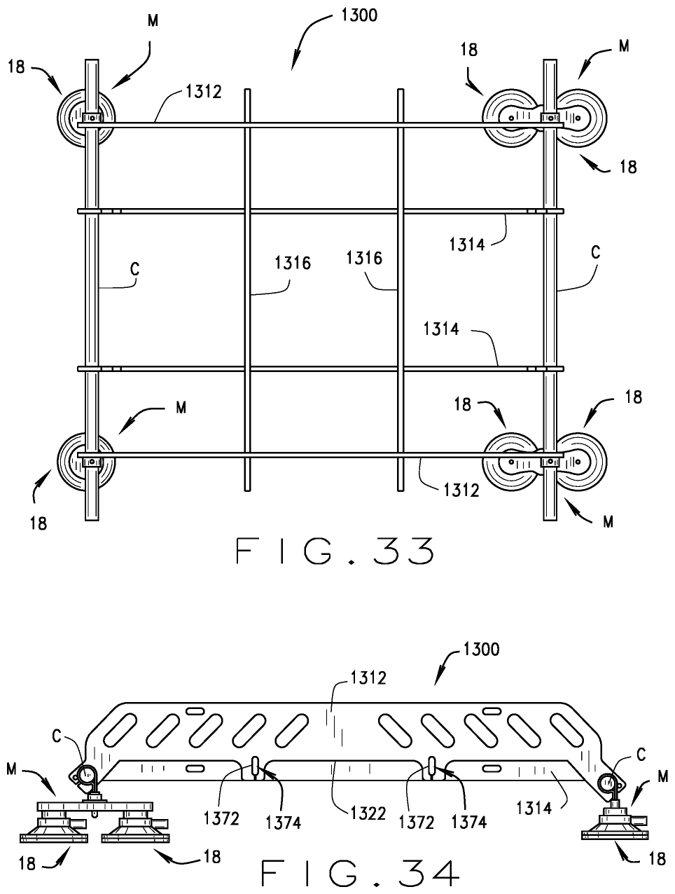

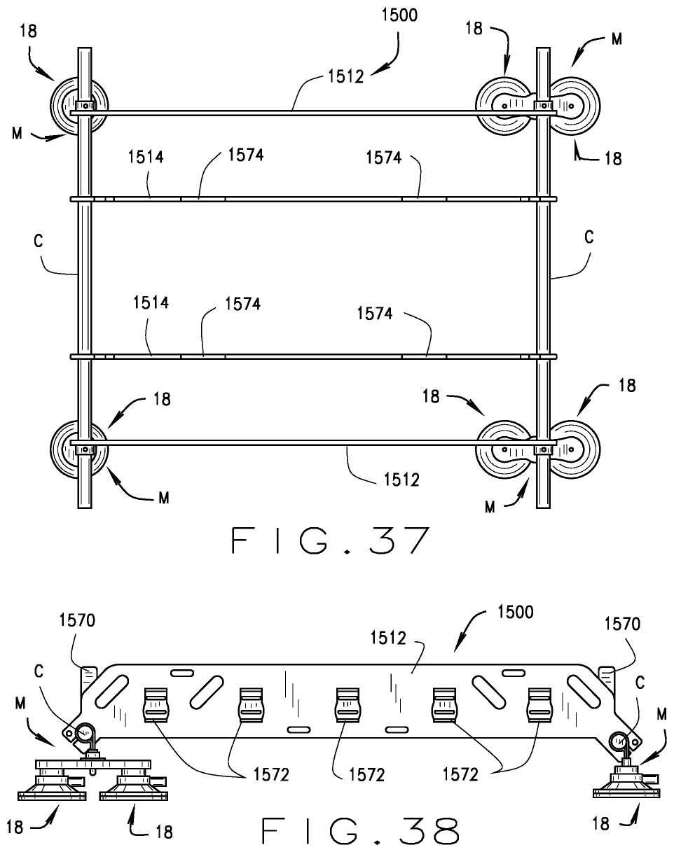

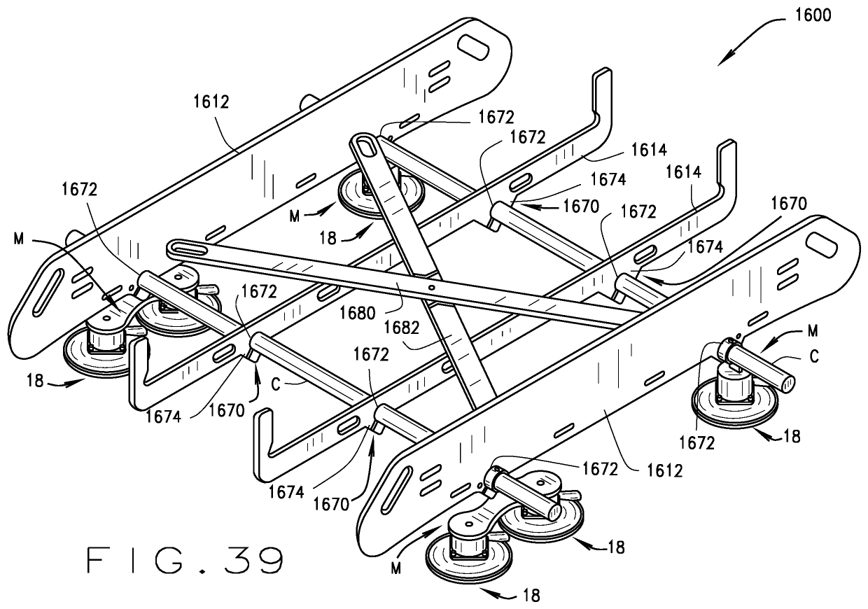

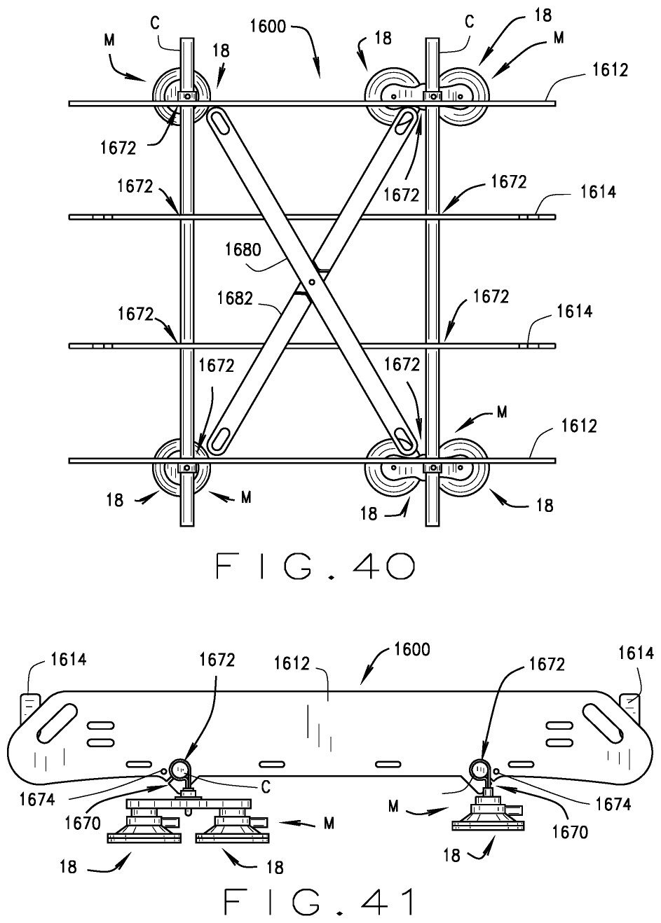

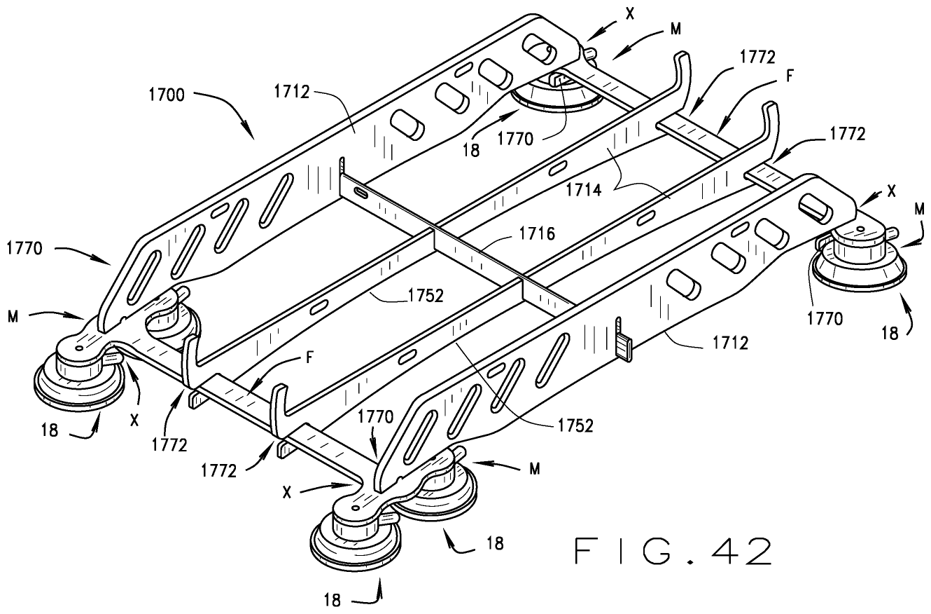

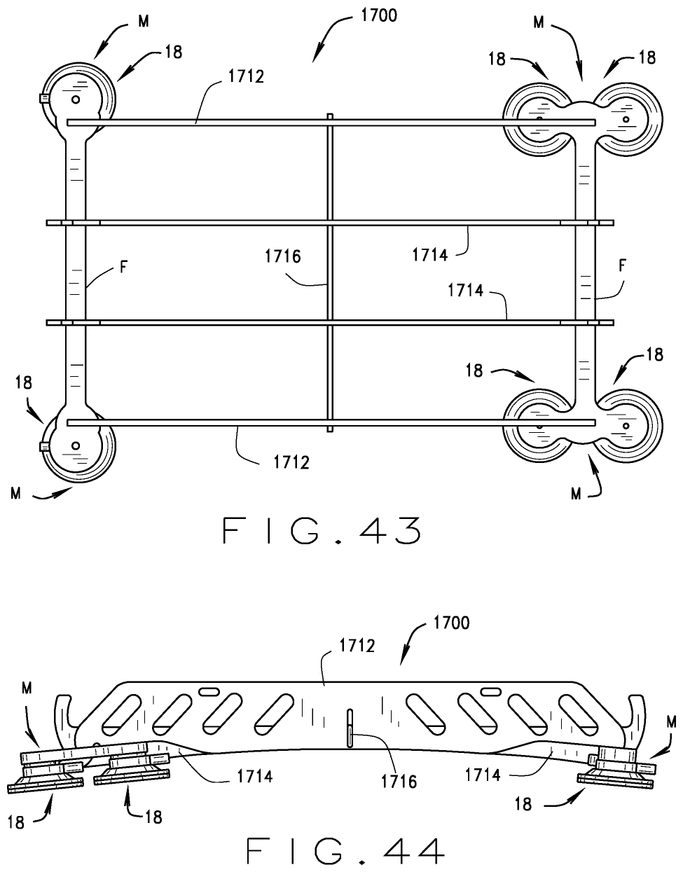

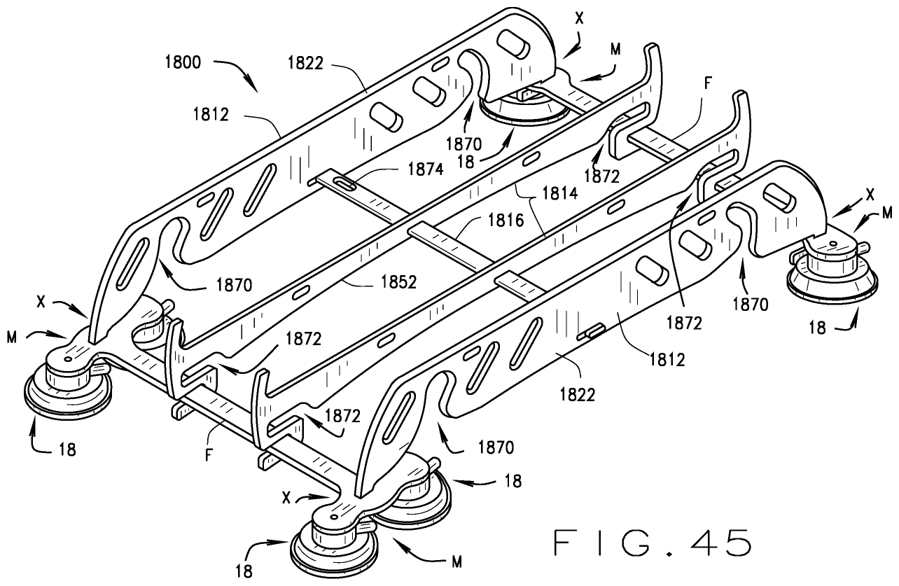

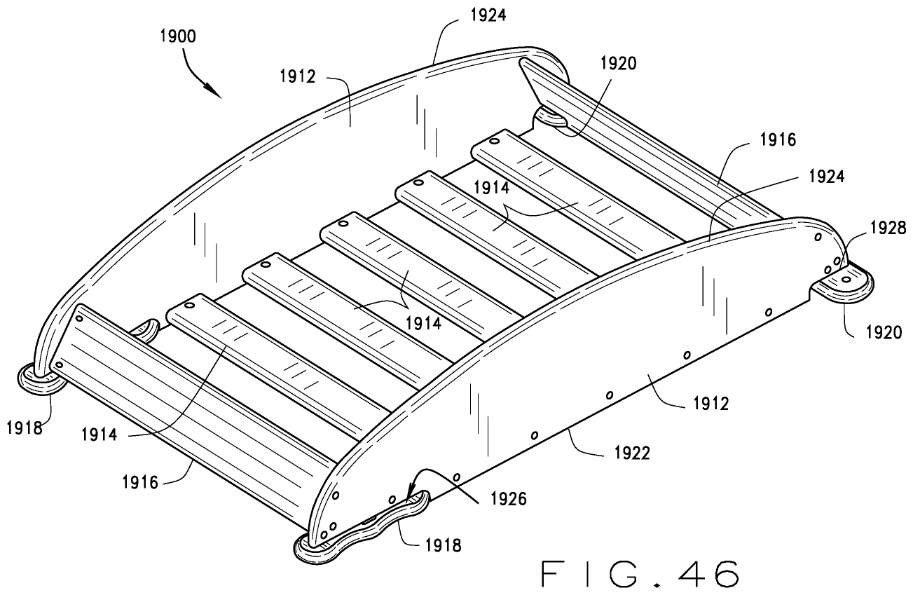

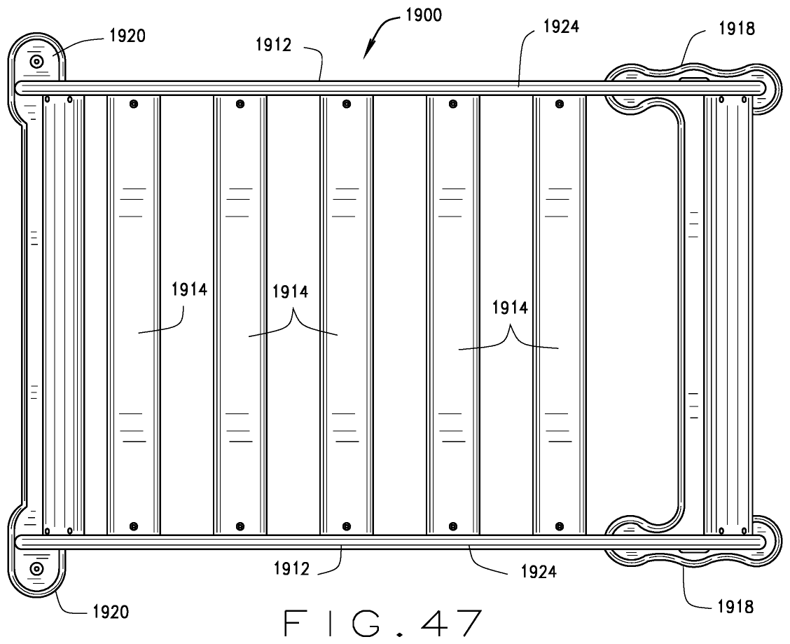

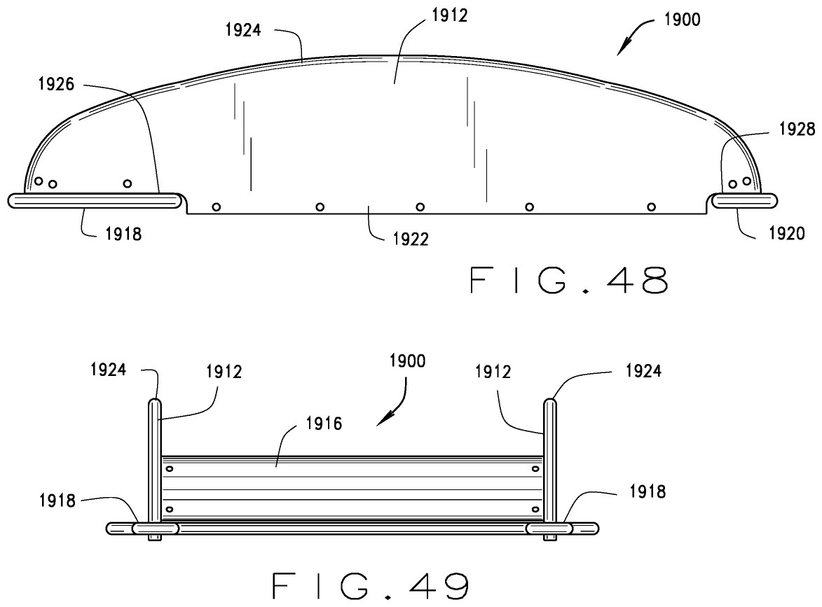

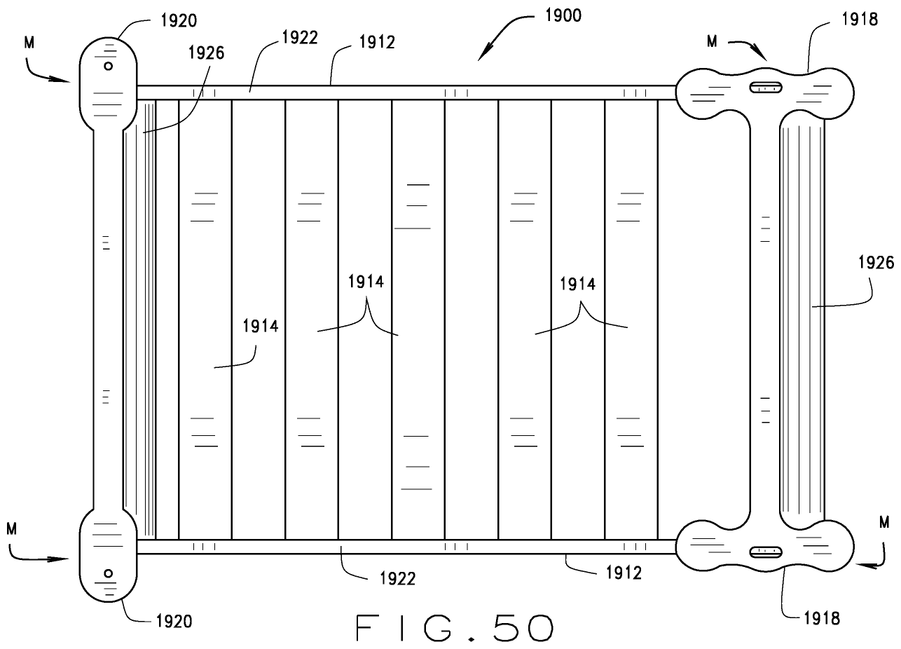

Turning now to FIGS. 24-50, a number of representative embodiments of the present disclosure, collectively referred to as cargo carriers, are therein depicted. In FIGS. 24-26, a third representative embodiment of the present disclosure, a cargo carrier 1010, includes two opposing, rigid, elongated and flat end mounts or braces 1012 approximately one-half inch thick each, two flat and rigid inner cross braces 1014, and a flat and rigid central rib 1016. Each of said end braces 1012 and inner braces 1014 is constructed from compressed board (or other such similarly rigid and workable material, such as for example, plywood, rigid plastic, light weight metals such as aluminum, and carbon fiber). Each of said end braces 1012 and inner braces 1014 is shaped and sized to releasably attach to the cross support tubes C of a vehicle vacuum mount M previously presented by the applicant, which can be seen for example in International Application WO 2018/227203.

The opposing end braces 1012 are identical and each comprises a relatively horizontal and straight top edge 1020, a relatively horizontal and straight bottom edge 1022 that at one end has a shallow inverse concave curve 1024 leading upward to a first side edge 1026 and a matching shallow inverse concave curve 1028 leading upward to a second side edge 1030 opposite the first side edge 1026. Each of the side edges 1026 and 1030 are generally straight, but sloped inward toward each other at an angle of approximately 60 degrees. The top edge 1020 is relatively flat and straight and extends between the upper ends of the side edges 1026 and 1030. A series of four straight and parallel inward sloping slots 1032, each having a length of approximately four inches and a width of approximately one inch, are formed in each side of each end brace 1012. Each end brace 1012 further has a short, vertical, downward facing, open-ended slot 1034 positioned in the center of the bottom edge 1022. The slot 1034 is shaped and sized to snugly receive and hold vertical one end of the central rib 1016, as shown. A removable bracket 1035 attaches to the edge brace 1012 along the bottom edge 1022 over the slot 1034 to secure the central rib 1016 in the slot 1034. Although the bracket 1035 is shown to attach to the edge brace 1012 with a set of pins, a wide variety of releasable fasteners and attachment configurations, well known in the art, can alternatively be used.

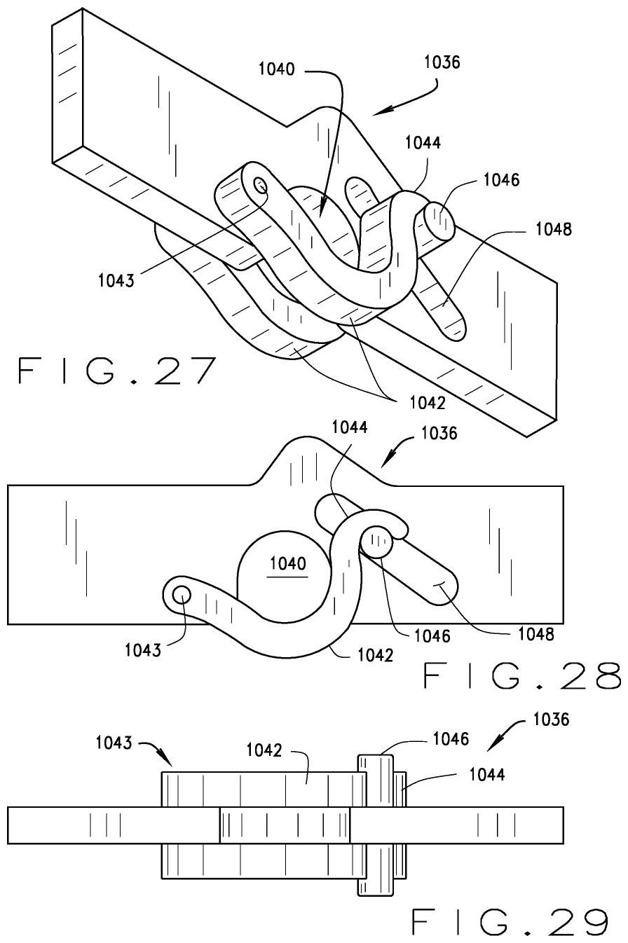

Each end brace 1012 also includes a pole latch 1036 positioned at and extending from each opposing end of the brace 1012 where the bottom edge 1022 meets the bottom of the side edges 1026 and 1030. The pole latches 1036 are adapted to releasably attach to a pole or rod, such as one of the cross support tubes C of a vehicle vacuum mount M previously presented by the applicant, which can be seen for example in International Application WO 2018/227203. As can be seen, the pole latches 1036 each comprise a circular opening sized to fit snugly over the pole C and a screw clamp on the distal end of each latch 1036 to tighten the pole latch 1036 onto the pole C. As can be seen in the magnified views of FIGS. 27-29, the pole latches 1036 may alternatively each comprise a semi-circular concave opening 1040 along the brace 1012 across which span on each side of the end brace 1012 a pair of matching arched cuffs 1042 that are rotatably secured to the end brace 1012 by a cross pin 1043 about which each of the cuffs 1042 may pivot. (Although the pole latch shown in FIGS. 27-29 are oriented along a central portion of a brace and not at an end, the configuration and operation of the pole latch as depicted remains the same for the specific pole latches 1036). As can readily be understood, when the cuffs 1042 pivot to a closed position as shown in FIG. 27, the pole latch 1036 may securely close about the tube C. Each of the cuffs 1042 further has an outwardly turned tail 1044 that mates with a cross pin 1046 adjustably positioned in an angular slot 1048 in the end brace 1012. The cross pin 1046 releasably maintains the cuffs 1042 in the closed position when securing the end brace 1012 to a tube C positioned in the pole latch 1036. The cuffs 1042 can be released from the closed position merely by sliding the cross pin 1046 downward in the slot 1048 away from the opening 1040.

Each of the inner braces 1014 is likewise identical and each comprises a relatively horizontal and straight top edge 1050 and an opposing relatively horizontal and straight bottom edge 1052. Of course, the cargo carrier 1010 is not restricted to have two inner braces 1014, but may comprise a single inner brace 1014 or more than two inner braces 1014, so long as the central rib 1016 is configured to mate with the appropriate number of braces 1014. One end of the bottom edge 1052 of each inner brace 1014 has a shallow upward curve 1054 leading to a pole latch 1056 that extends from the end of the top edge 1050. The opposite end of the bottom edge 1052 has a shallow upward curve 1058 that leads to a pole latch 1060 that extends from the end of the top edge 1050. The pole latches 1056 and 1060 are generally configured the same as the pole latches 1036, as explained hereinabove. Each of the inner braces 1014 further has a short, vertical, upward facing, open-ended slot 1062 positioned in the center of the top edge 1050. The slot 1062 is shaped and sized and positioned along the top edge 1050 to snugly receive and hold vertical the central rib 1016, as shown.

The central rib 1016 spans in a perpendicular fashion between the slots 1034 in the bottom edges 1022 of each end brace 1012. In so doing, the central rib 1016 intersects each of the inner braces 1014 and is cradled in each of the slots 1062. The central rib 1016 thereby structurally joins both end braces 1012 and both inner braces 1014 in rigid fashion.

As can be appreciated, the cargo carrier 1010 can be readily disassembled and removed from cross support tubes C of a vehicle vacuum mount M as shown, simply by releasing the pole latches 1036, 1056 and 1060 from the tubes C, and removing the brackets 1035 from under the central rib 1016. This results in a collection of components—the two flat end braces 1012, the two flat inner braces 1014 and the central rib 1016—that can lie flat against each other in a small, compact and portable bundle for ready storage or transport.

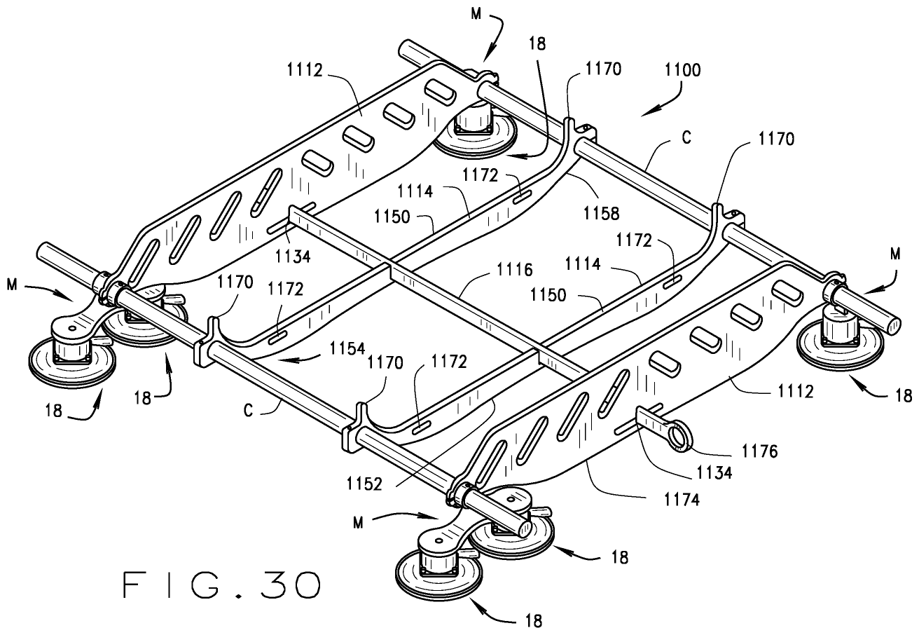

A fourth representative embodiment of the present disclosure, generally referred to as a cargo carrier 1100, is shown in FIG. 30 and has the same features as the cargo carrier 1010, with modifications as described hereafter. First, each inner brace 1114 includes a tab or finger 1170 that extends generally upward from its respective end nearly perpendicular above a top edge 1150. Second, each inner brace 1114 includes a horizontal slot 1172, having a length of approximately one inch and a width of approximately one-half inch, positioned above upwardly curved ends 1154 and 1158 of bottom edge 1152. These fingers 1170 and slots 1172 provide attachment features for securing items in the cargo carrier 1100 or attaching a sidewall, fabrics or other accessories, to protect, cover or otherwise secure items in the cargo carrier 1100. Third, there is no bracket 1035 holding the central rib 1116 in place. Instead, the slots 1134 in each of brace 1112 are closed, and one end of the central rib 1116 forms a vertically oriented ring 1176, having an inner diameter of approximately one inch and an outer diameter of approximately two inches, that allows the user to readily insert and withdraw the central rib 1116 from the slots 1134 in the end braces 1112.

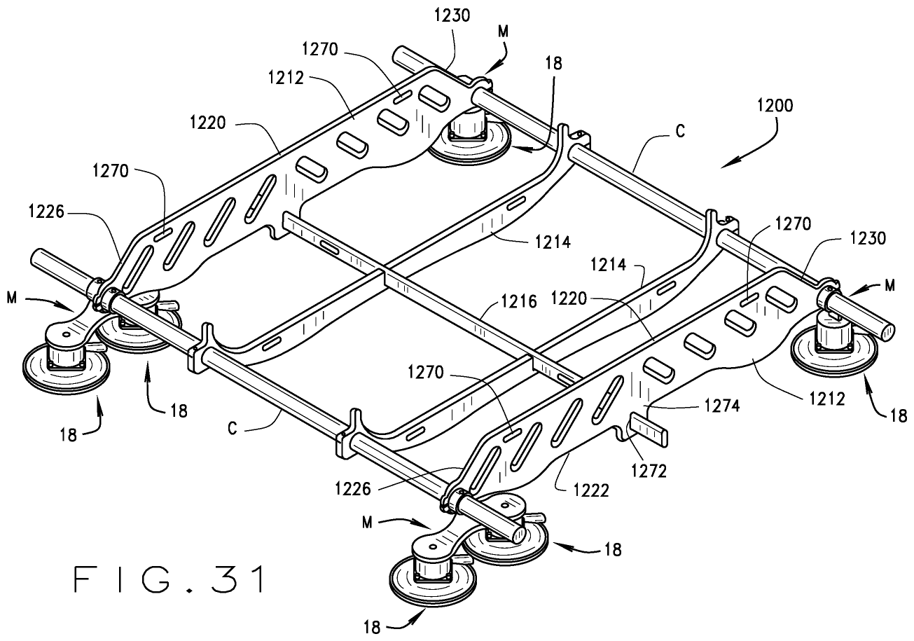

A fifth representative embodiment of the present disclosure, generally referred to as a cargo carrier 1200, is shown in FIG. 31 and has the same features as the cargo carrier 1100, with modifications as described hereafter. First, each end brace 1212 includes a horizontal slot 1270, having a length of approximately one inch and a width of approximately one-half inch, positioned near top edge 1220 just inside the intersections of top edge 1220 and side edges 1226 and 1230, as shown. These slots 1270 provide attachment features for securing items in the cargo carrier 1200 or attaching a sidewall, fabrics or other accessories, to protect, cover or otherwise secure items in the cargo carrier 1200. Second, a closed vertical slot 1272 in each end brace 1212 attaches the central rib 1216 to its respective end brace 1212, as shown. The slot 1272 is positioned in an extension or tab 1274 that extends downward from the center of each end brace's bottom edge 1222. Third, the central rib 1216 includes two horizontal closed slots, having a length of approximately two inches and a width of approximately one-half inch, each positioned between an inner brace 1214 and its corresponding end brace 1212. These slots 1270 also provide attachment features for securing items in the cargo carrier 1200 or attaching a sidewall, fabrics or other accessories, to protect, cover or otherwise secure items in the cargo carrier 1200.

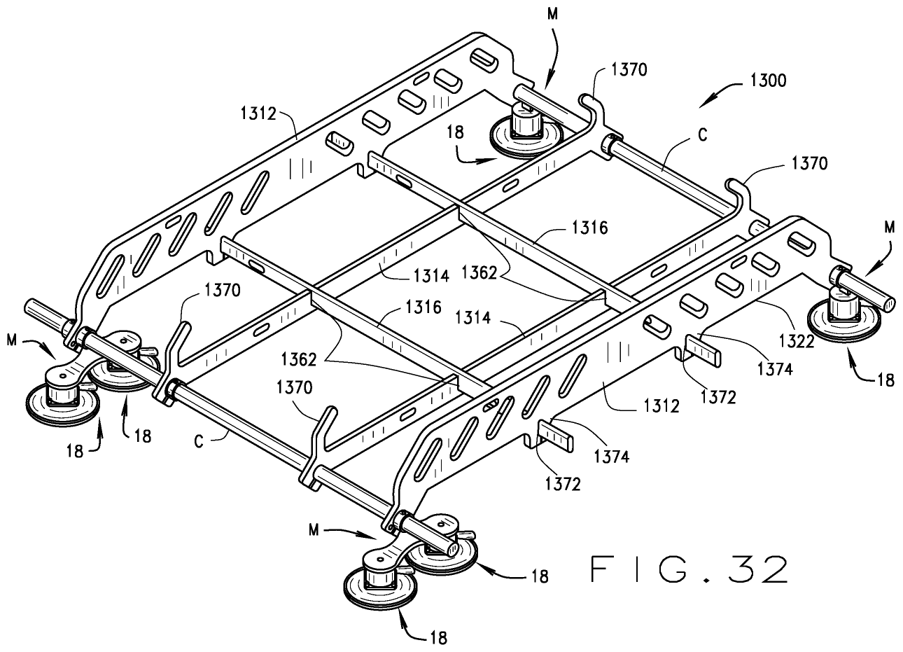

A sixth representative embodiment of the present disclosure, generally referred to as a cargo carrier 1300, is shown in FIGS. 32-34 and has the same features as the cargo carrier 1200, with modifications as described hereafter. First, each of the tabs or fingers 1370 that extends generally upward from the ends of the inner braces 1314 are taller than the fingers 1170, and curve inward slightly. Second, the cargo carrier 1300 has two parallel ribs 1316 instead of a single central rib 1016, 1116 or 1216. As in the cargo carrier 1200, each of the ribs 1316 is positioned snugly in a closed vertical slot 1372, and each of the slots 1372 is positioned in an extension or tab 1374 that extends downward from the center of the bottom edge 1322 of the end braces 1312.

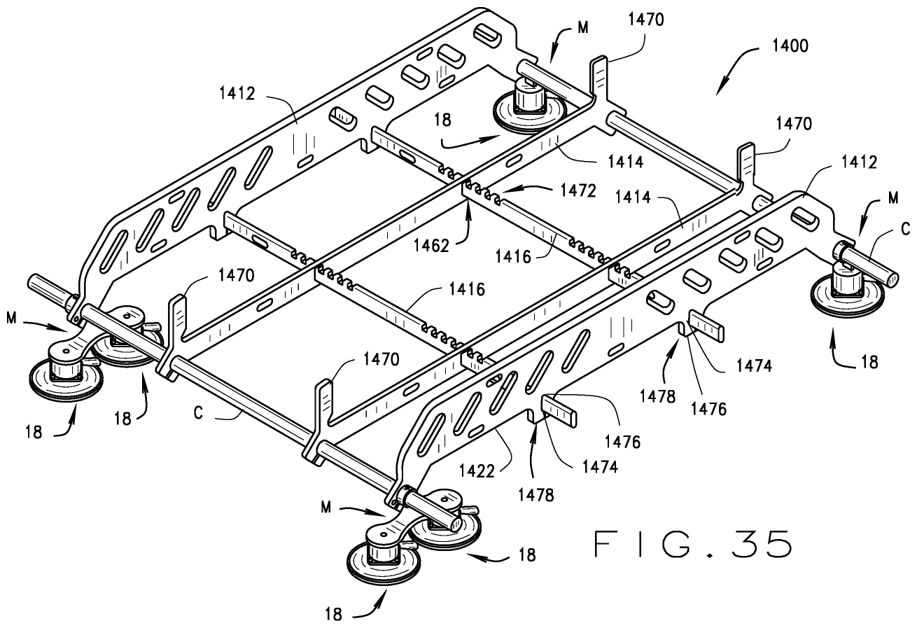

A seventh representative embodiment of the present disclosure, generally referred to as a cargo carrier 1400, is shown in FIG. 35 and has the same features as the cargo carrier 1300, with modifications as described hereafter. First, each of the tabs or fingers 1470 that extends generally upward from the ends of the inner braces 1414 are taller and wider than the fingers 1370, and do not curve inward but simply extend vertically. Second, instead of having open slots 1362 in which the ribs 1316 are set into, the cargo carrier 1400 has two vertical closed slots 1462 and each of the ribs 1416 has a series of close-set cross-grooves 1472 along its upper edge in proximity to the slots 1462 when the cargo carrier 1400 is assembled. The grooves 1472 mate with the slots 1462 and form a tight attachment when weight is placed upon the inner braces 1414. Third, each of the slots 1474 holding the ribs 1416 to the end braces 1412 in tabs 1476 is open along the bottom edge 1422 of the end brace 1412. A pivot screw 1478, or other similar releasable fastener, closes the bottom of the slot 1474.

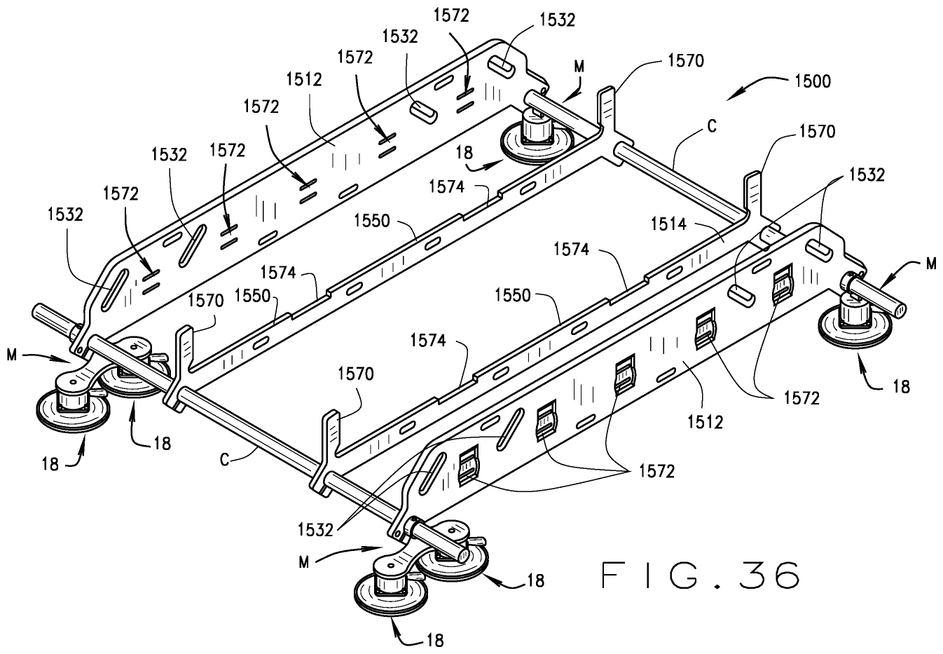

An eighth representative embodiment of the present disclosure, generally referred to as a cargo carrier 1500, is shown in FIGS. 36-38, which has the same features and configuration as the cargo carrier 1400 with modifications as described hereafter. Like the cargo carrier 1400, the cargo carrier 1500 has two end braces 1512, and two inner braces 1514, and each of the inner braces 1514 has a tab or finger 1570 that extends generally upward from the ends of the inner braces 1514, with the finger 1570 configured the substantially the same as the finger 1470. However, in the cargo carrier 1500 there are no ribs or other bracing that extend between the end braces 1512 other than the cross support tubes C on each side. Further, the end braces 1512 have only two angular slots 1532 on each side instead of four. In addition, each end brace 1512 has a series of five strap ports 1572, while a pair of grooves or shallow depressions 1574 are formed in the upper edge 1550 of each of the inner braces 1514.

A ninth representative embodiment of the present disclosure, generally referred to as a cargo carrier 1600, is shown in FIGS. 16-18, having a configuration similar to previous configurations but with modifications as described hereafter. In this configuration, the end braces 1612 and inner braces 1614 are not secured to the cross support tubes C of a vehicle vacuum mount M with pole latches at the distal ends of the braces as in previous embodiments. Rather, the end braces 1612 and inner braces 1614 are secured to the support tubes C with slotted bores 1670 as shown. Each of the slotted bores 1670 has a bore 1672, a slot 1674 that extends from the bore 1672 to an outer edge of the brace 1612 or 1614, and a hand-turnable screw (not shown) that extends through the brace 1612 or 1614 and across the slot 1674. The bore 1672 is sized to slidably receive the cross support tube C of the vehicle vacuum mount M. When a cross support tube C is positioned in a slotted bore 1670, the hand-turnable screw can be tightened to close the slot 674 and thereby tighten the slotted bore 1670 around the cross support tube C. The cargo carrier 1600 is also constructed with each of the slotted bores 1670 being positioned four to six inches inward from the ends of the braces 1612 and 1614 such that the braces 1612 and 1614 extend some length, approximately six inches, outward beyond the cross support tubes C. In addition, the cargo carrier 1600 further has a pair of flat ribs 1680 and 1682 that are pivotally joined at their centers to form a scissor-like structure that can be opened and placed atop the braces 1612 (as shown in FIGS. 16 and 17) or collapsed together in a flat and compact single unit as when a closing a pair of scissors (not shown). The ribs 1680 and 1682 extend diagonally across the top of the inner braces 1614 and reach the outer braces 1612, and thereby can provide added structure and stress distribution across the “bed” of the cargo carrier 1600.

A tenth representative embodiment of the present disclosure, generally referred to as a cargo carrier 1700, is shown in FIGS. 19-21, having a configuration similar to previous configurations but with modifications as described hereafter. The cargo carrier 1700 is adapted to releasably attach to the top of a flat cross support F of a vehicle vacuum mount M previously presented by the Applicant, which can be seen for example in International Application WO 2018/227203. The cross support F has a horizontal closed slot X at each end. In this configuration, the end braces 1712 and inner braces 1714 are not secured to the vehicle vacuum mount M with pole latches as in previous embodiments. Instead, each of the end braces 1712 has a downward directed flat hook 1770 at each end that is sized and shaped to mate with and extend through one of the closed slots X in the cross support F. Each of the inner braces 1714 has a horizontal open slot 1772 at each end that is sized and shaped to receive the cross support F as shown. In addition, the bottom edge 1752 of each of the inner braces 1714 is slightly arched upward along its entire span, to provide for flex or a torsional bias in the inner braces 1714 when subjected to a top load.

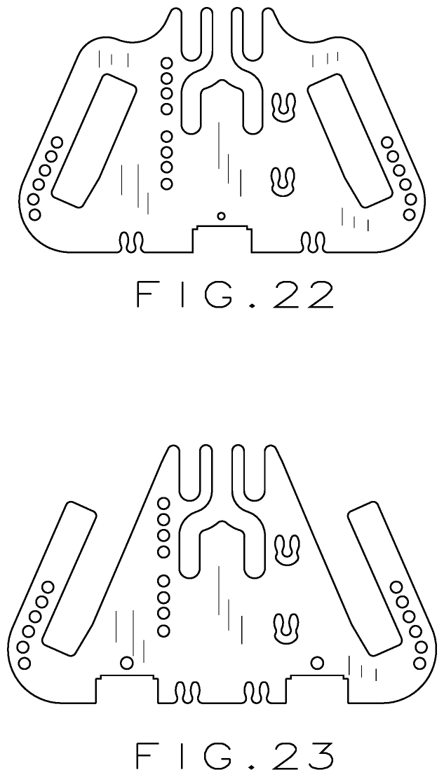

An eleventh representative embodiment of the present disclosure, generally referred to as a cargo carrier 1800, is shown in FIG. 22, having the same features and configuration as the cargo carrier 1700 with certain modifications. In this cargo carrier 1800 configuration, the end braces 1812 and inner braces 1814 are elevated such that their respective bottom edges 1822 and 1852 are horizontally above both of the cross supports F of the vehicle vacuum mount M. Further, the end braces 1812 and inner braces 1814 each have torsion slots 1870 and 1872, respectively, at each end that provide for flex or a torsional bias in the braces when subjected to a top load. In addition, the bottom edge 1852 of each of the inner braces 1814 is slightly arched upward along its entire span, to further provide for flex or a torsional bias in the inner braces 1814 when subjected to a top load. As can also be seen, the central rib 816 is flat with a short, linear closed slot 1874 near each end.

A twelfth representative embodiment of the present disclosure, generally referred to as a cargo carrier 1900, is shown in FIGS. 23-27. The cargo carrier 1900 is adapted to releasably attach to a set of vacuum mounts or the top of a cross support C of a vehicle vacuum mount M previously presented by the applicant, both of which can be seen for example in International Application WO 2018/227203. The cargo carrier 1900 has two parallel flat side braces or rails 1912, five horizontal flat base braces 1914, two angled flat end braces or rails 1916, two first fastening plate 1918 and a second fastening plate 1920. Each side rail 1912 has a flat horizontal bottom edge 1922 and an arched upper edge 1924. A shallow long notch 1926 is formed at one end of the bottom edge 1922, and a shallow short notch 1928 is formed at the opposite end. Each of the base braces 1914 extends between the two side rails 1912 along the bottom edge 1922, where their ends are attached to the inner surface of the side rails 1912 with screws or bolts. The base braces 1914 are equally spaced from each other along the length of the side rails 1912. Similarly, the end rails 1916 extends between the two side rails 1912, where the ends of the side rails 1916 are attached to the inner surface of the side rails 1912 with screws or bolts. In contrast to the base braces 1914, the end rails 1916 are oriented at an angle relative to the bottom edges 1922 of the side rails 1912, such that the end rails 1916 each rise from the far ends of the side rails 1912 near the bottom edges 1922 and rise upward and slope or slant inward along each end of the upper edges 1924. Each end of the first fastening plate 1918 is positioned in part in one of the long notches 1926, and providing a horizontal mounting surface to attach vacuum devices or attach the cargo carrier 1900 to a cross support, such as C or F, of a vehicle vacuum mount M. Likewise, each end of the second fastening plate 1920 is positioned in part in one of the short notches 1928, and providing a horizontal mounting surface to attach vacuum devices or attach the cargo carrier 1900 to a cross support, such as C or F, of a vehicle vacuum mount M.

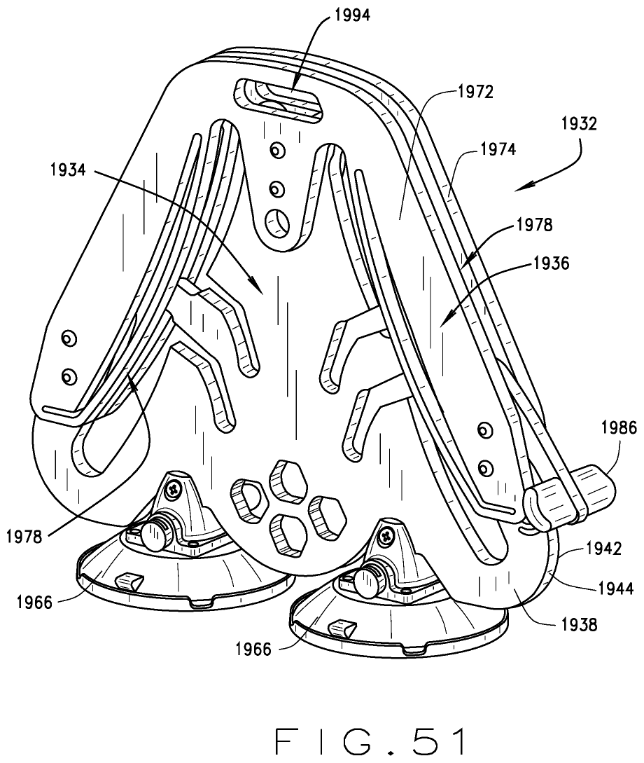

FIG. 51 is a representation of a further embodiment of the support rack 1932 of this disclosure. The support rack 1932 shown in FIG. 51 is basically comprised of a mounting board 1934 and a clamp 1936 releasably attached on the mounting board. The mounting board 1934 and clamp 1936 are constructed of basically the same materials employed in constructing the mounting boards of previously described embodiments, or equivalents of those materials.

The mounting board 1934 is a flat, rigid panel and has opposite first 1938 and second 1942 surfaces that are flat, parallel surfaces. The opposite first 1938 and second 1942 surfaces define a planar configuration of the mounting board 1934. The mounting board 1934 has a peripheral edge surface 1944 that extends completely around the periphery of the mounting board 1934. The peripheral edge surface 1944 defines a peripheral configuration of the mounting board 1934.

A plurality of notches 1946, 1948, 1952 are formed in the mounting board 1934. The notches 1946, 1948, 1952 have respective notch openings 1954, 1956, 1958 formed through the peripheral edge surface 1944 of the mounting board 1934. The notches in the mounting board 1934 can be fewer in number than those represented in FIG. 51 or could be greater in number than those represented in FIG. 51. The notches 1946, 1948, 1952 define slots 1946, 1948, 1952 in the mounting board 1934. As with the earlier described embodiments of the mounting board, the slots 1946, 1948, 1952 have configurations for receiving items in the slots and securing the items in the slots. The slots 1946, 1948, 1952 have different configurations for receiving different items in the slots and securing the different items to the mounting board 1934. The earlier described straps 20, 22 could be used with the slots 1946, 1948, 1952 in releasably securing items to the mounting board 1934 in the same manner as that previously described. For example, the handles 32, 33 at the opposite ends of the straps 20,22 could be configured to be releasably attached or fit inside a slot of the slots 1946, 1948, 1952 to releasably attach a strap to the mounting board 1934 and thereby attach an item around which the strap 20, 22 is wrapped to the mounting board.

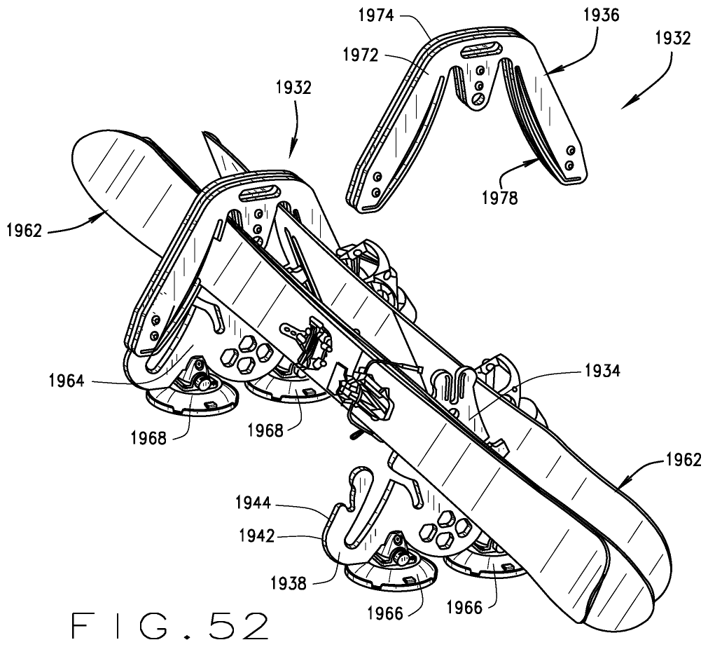

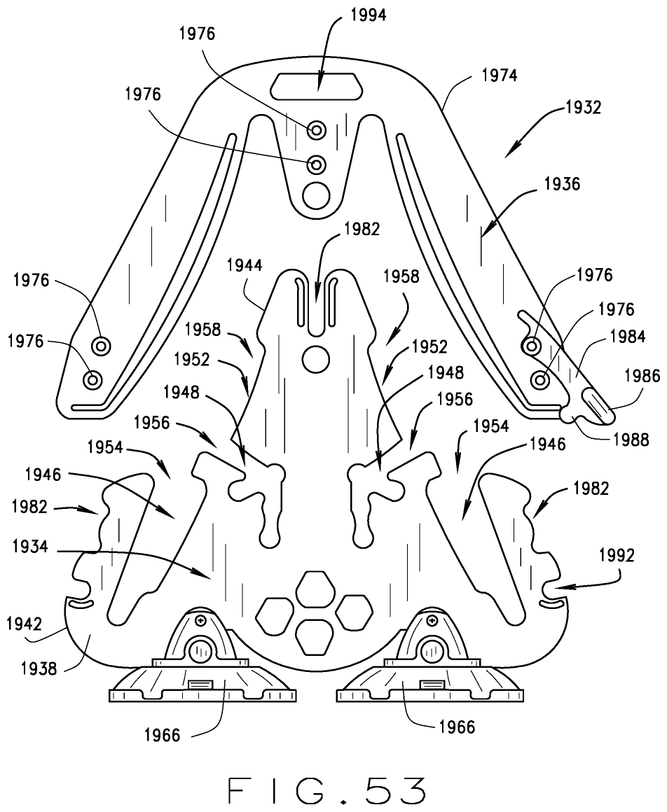

FIG. 52 is a representation of items 1962, for example ski equipment that have been inserted into the slots 1946, 1948, 1952 of the mounting board 1934 in attaching the items to the mounting board. Also represented in FIG. 52 is the first mounting board 1934 employed in combination with a second mounting board 1964. As represented in FIG. 52, the first mounting board 1934 and the second mounting board 1964 have configurations that are substantially same configurations. The items or ski equipment 1962 are inserted into the slots of the mounting boards 1934, 1964 in releasably attaching the items to the mounting boards. The slots 1946, 1048, 1952 are configured to have complementary configurations to the exterior surfaces of the ski equipment such as snow skis, ski poles, water skis, etc. so that the equipment is received in a snug, stationary fit in the slots. The slots can have other configurations than those shown in FIGS. 51-53 for receiving other types of items.

As represented in FIGS. 51 and 52, the mounting boards 1934 have devices 1964, 1968 attached to the bottoms of the respective mounting boards 1934, 1964. The devices 1966, 1968 are devices such as those previously described that function or are operable to detachably attach the respective mounting boards 1934, 1964 in vertical orientations of the mounting boards to a separate surface as represented in FIGS. 51 and 52. As represented in FIG. 52, the devices 1966, 1968 of the respective mounting boards 1934, 1964 are operable to detachably attach the first mounting board 1934 and the second mounting board 1964 to a separate surface with different distances between the first mounting board 1934 and the second mounting board 1964 attached to the separate surface. Repositioning the mounting boards 1934,1964 on the separate surface adjusts the distance between the mounting boards. As represented in FIG. 52, the first mounting board 1934 and the second mounting board 1964 are configured for a first cross support item 1962, for example an item of ski equipment to be releasably attachable to the first mounting board 1934 and the second mounting board 1964. In this manner, the item 1962 or ski equipment maintains a distance between the first mounting board 1934 and the second mounting board 1964 releasably attached to the item 1962.

As represented in FIGS. 51-53, the support rack 1932 also comprises a clamp 1936 in combination with the mounting board 1934. A clamp 1936 could be constructed of the same materials employed in constructing the mounting board 1934, or equivalent materials.

The clamp 1936 is constructed with an inverted “V” shaped configuration or a configuration that substantially corresponds with the configuration of the upper portion of the peripheral edge surface 1944 of the mounting board 1934. The clamp 1936 is constructed of a first panel 1972 and a second panel 1974 that have substantially same configurations. The first panel 1972 and second panel 1974 are connected by fasteners 1976. The fasteners 1976 are constructed to connect the first panel 1972 and second panel 1974 with a small spacing between the panels. The small spacing defines a slot 1978 between the first panel 1972 and second panel 1974. The slot 1978 is dimensioned to receive the peripheral edge surface 1944 and an upper portion or a top portion of the mounting board 1934 in the slot 1974 when the clamp 1936 is positioned on top of the mounting board 1934 as represented in FIG. 51. The fasteners 1976 are positioned on the clamp 1936 to engage in fastener slots 1982 formed in the peripheral edge surface 1944 of the mounting board 1934 to positively position the clamp 1934 on the mounting board 1934. The engagement of the fasteners 1976 in the fastener slots 1982 prevents movement, and in particular side-to-side movement of the clamp 1936 on the mounting board 1934.

As represented in FIG. 53, one of the fasteners 1976 mounts a lock in the form of a lock lever 1984 on the clamp 1936. The lock lever 1984 is mounted between the first panel 1972 and the second panel 1974 for pivoting movement of the lock lever 1984 on the clamp 1936 between the panels 1972,1974. The lock lever 1984 has a manual tab 1986 attached to an end of a lock lever opposite the fastener 1976 that pivotally attaches the lock lever 1984 to the clamp 1936. A lock post 1988 projects from the lock lever 1984 adjacent the manual tab 1986. The lock post 1988 is dimensioned to fit into a lock notch 1992 formed in the peripheral edge surface 1944 of the mounting board 1934. When the manual tab 1986 is manually manipulated to pivot the lock lever 1984 and insert the lock post 1988 in the lock notch 1992, the clamp 1936 is locked to the mounting board 1934 and cannot be removed from the mounting board 1934. Locking the clamp 1936 to the mounting board 1934 also locks the items 1962 supported on the mounting board 1934 to the mounting board. Manually manipulating the manual tab 1986 in the opposite direction pivoting the lock lever 1984 in the opposite direction causes the lock post 1988 to be withdrawn from and out of the lock notch 1992 in the mounting board 1934. This unlocks the clamp 1936 from the mounting board 1934 and enables the clamp to be removed from the mounting board.

The clamp 1936 is also provided with a manual grip 1994 on the clamp. The manual grip 1994 is basically a hole through the top of the clamp 1936 that is dimensioned and configured to enable a hand or more specifically the fingers of a hand to be extended through the opening and grasp the manual grip 1994. With the clamp 1936 or clamps as represented in FIG. 52 attached to their respective mounting boards 1934,1964 with items 1962 secured between the mounting boards 1934,1964 and the clamps 1936, manually gripping the manual grips 1994 and lifting and moving the clamps 1936 attached to the mounting boards 1934,1964 enables the items 1962 to be easily moved.

The various collapsible racks and carriers described and depicted herein permit a user to quickly and easily assemble and disassemble such racks and carriers for ease of use and convenient storage.

While Applicant has described in the detailed description several configurations that may be encompassed within the disclosed embodiments of this invention, numerous other alternative configurations, that would now be apparent to one of ordinary skill in the art, may be designed and constructed within the bounds of Applicant's invention as set forth in the claims. Moreover, the above-described novel mechanisms of the present invention, shown and described by way of example herein as various alternative embodiments can be arranged in a number of other and related varieties of configurations without departing from or expanding beyond the scope of Applicant's invention as set forth in the claims.

For example, the cords 30 and 52 need not be “bungee” cords, but can be constructed of a variety of elastic materials, including for example rubber and various polymers, so long as the material is sufficiently durable and elastic, and provides the same or better functionality as required of the cords 30 and 52 as disclosed herein. Further, the straps 20 need not be limited to having the handles shaped exactly as shown, but may instead have a variety of shapes and sizes so long as the straps 20 are able to perform their functions as outlined herein. Similarly, the straps 22 need not be limited to having the ball 54 shaped exactly as shown, but may instead have a variety of shapes and sizes so long as the straps 22 are able to perform their functions as outlined herein.

By way of further example, the mounting boards 14 and 114 need not have the specific configuration or shape as shown, but may be constructed in a variety of shapes with a variety of attachment features, so long as the shape enables a user to place one or more desired items, such as skis or snowboards and related equipment, on the mounting board and secure such items to the mounting board. Examples of alternate embodiments of the mounting boards 14 and 114 are shown in FIGS. 19-23. Additionally, both of the mounting boards 14 in a ski rack 10 need not be identical, but can differ in shape, so long as the differences in shape do not preclude the placement of one or more desired items, such as skis or snowboards and related equipment, on the mounting board and the securing such items to the mounting board. Similarly, both of the mounting boards 114 in a ski rack 100 need not be identical. Further, each ski rack 10 and ski rack 100 can comprise as little as one mount 12 or mount 112 or more than two mounts 12 or 112, respectively.

By way of further example, although each of the embodiments of the collapsible ski rack and carrier depict a variety of attachment structures, such for example as the features 14a-14d and the slots 1032 and the tabs 1370, such attachment structures are not limited to the precise shapes, sizes and locations so depicted. Rather, such attachment structures may comprise, for example, an open slot, a closed slot, an opening, an arm, a notch, a protrusion, a keyhole, and a hook—so long as such attachment structures can provide the functions as set forth in this disclosure.

Further, the vacuum devices need not be attached at the precise location for each of the embodiments of the collapsible ski rack and carrier. Rather, the vacuum devices may be attached at various locations on the mounting boards and/or braces, so long as the vacuum devices are positioned on the ski rack and/or carrier in a structurally sound location and enable ready vacuum attachment to a vehicle.

Further, although each of the embodiments of the collapsible ski rack and carrier depict a number of components that are separable for ready disassembly, various of the components may be rigidly attached to one another. For example, the vacuum devices may be rigidly attached to any one or more of the ski racks and/or carriers instead of being removable. While such configurations may reduce the overall effective compaction that may otherwise be achieved by the depicted configurations, such alternate configurations will still provide significant benefits over traditional racks and carriers.

Additional changes can be made in the above constructions without departing from the scope of the disclosure, it is intended that all matter contained in the above description or shown in the accompanying drawings shall be interpreted as illustrative and not in a limiting sense.

1. A support rack comprising:
a mounting board, the mounting board being a flat and rigid panel;
devices attached to a bottom of the mounting board, the devices being operable to detachably
attach the mounting board in a vertical orientation to a separate surface; and
slots in the mounting board, the slots being dimensioned to enable placing items upon the
mounting board and securing the items to the mounting board.

2. The support rack of claim 1, further comprising:
the slots in the mounting board having configurations for receiving items in the slots and
securing the items in the slots to the mounting board.

3. The support rack of claim 2, further comprising:
the slots in the mounting board having different configurations for receiving different items in the slots and securing the different items to the mounting board.

4. The support rack of claim 1, further comprising:
a strap, the strap being releasably attachable to the mounting board, the strap being dimensioned to extend around an item placed upon the mounting board and secure the item to the mounting board.

5. The support rack of claim 4, further comprising:
a first handle attached to a first end of the strap, the first handle being configured to be releasably attached inside a slot of the slots in the mounting board to releasably attach the strap to the mounting board.

6. The support rack of claim 1, further comprising:
the mounting board being a first mounting board;
a second mounting board, the second mounting board being flat and rigid;
devices attached to a bottom of the second mounting board, the devices attached to the bottom of the second mounting board being operable to detachably attach the second mounting board in a vertical orientation to a separate surface; and
slots in the second mounting board, the slots being dimensioned to enable placing items
upon the second mounting board and securing the items to the second mounting board.

7. The support rack of claim 6, further comprising:
the first mounting board and the second mounting board having substantially same configurations.

8. The support rack of claim 7, further comprising:
the devices of the first mounting board and the devices of the second mounting board being
operable to detachably attach the first mounting board and the second mounting board to a separate surface with different distances between the first mounting board and the second mounting board when attached to the separate surface.

9. The support rack of claim 8, further comprising:
the first mounting board and the second mounting board being configured for a first cross support item to be releasably attachable to the first mounting board and the second mounting board, whereby the first cross support item maintains a distance between the first mounting board and the second mounting board releasably attached to the first cross support item.

10. The support rack of claim 9, further comprising:
the first mounting board and the second mounting being configured for the first cross support item to be an item of ski equipment that maintains the distance between the first mounting board and the second mounting board releasably attached to the item of ski equipment.

11. A support rack comprising:
a first mounting board, the first mounting board being flat and rigid;
devices attached to a bottom of the first mounting board, the device is being operable to detachably attach the first mounting board oriented vertically to a separate surface;
slots in the first mounting board, the slots being dimensioned to enable placing items upon the first mounting board and securing the items to the first mounting board;
a second mounting board, the second mounting board being flat and rigid;
devices attached to a bottom of the second mounting board, the device is being operable to detachably attach the second mounting board oriented vertically to a separate surface; and
slots in the second mounting board, the slots being dimensioned to enable placing items upon the second mounting board and securing the items to the second mounting board.

12. The support rack of claim 11, further comprising:
the devices of the first mounting board and the devices of the second mounting board being operable to detachably attach the first mounting board and the second mounting board to a separate surface with different distances between the first mounting board and the second mounting board when attached to the separate surface.

13. The support rack of claim 12, further comprising:
the first mounting board and the second mounting board being configured for a first cross support item to be releasably attachable to the first mounting board and the second mounting board, whereby the first cross support item maintains a distance between the first mounting board and the second mounting board releasably attached to the first cross support item.

14. The support rack of claim 13, further comprising:
the first mounting board and the second mounting being configured for the first cross support item to be an item of ski equipment that maintains the distance between the first mounting board and the second mounting board releasably attached to the item of ski equipment.

15. A support rack comprising:
a mounting board, the mounting board being flat and rigid;
a peripheral edge surface on the mounting board, the peripheral edge surface extending around the mounting board;
notches in the mounting board, the notches extending through the peripheral edge surface of
the mounting board and defining slots in the mounting board, the notches having notch openings in the peripheral edge surface of the mounting board; and
a clamp removably attachable to the mounting board, the clamp being removably attachable over the peripheral edge surface of the mounting board and over the notch openings in the peripheral edge surface of the mounting board.

16. The support rack of claim 15, further comprising:
the mounting board having opposite first and second side surfaces that are flat and parallel and
define a planar configuration of the mounting board.

17. The support rack of claim 16, further comprising:
the clamp having a bottom surface;
a slot in the bottom surface of the clamp, the slot being dimensioned to receive a portion of the peripheral edge surface of the mounting board and a portion of the mounting board in the slot when the clamp is removably attached to the mounting board.

18. The support rack of claim 17, further comprising:
a lock on the clamp, the lock being operable to lock the clamp to the mounting board preventing the clamp from being removed from the mounting board when the clamp is locked to the mounting board, and to unlock the clamp from the mounting board enabling the clamp to be removed from the mounting board when the clamp is unlocked from the mounting board.

19. The support rack of claim 18, further comprising:
the lock is a lever that is manually movable on the clamp between a lock position on the clamp where the lever extends into a lock notch in the peripheral edge surface of the mounting board and an unlock position on the clamp where the lever is out of the lock notch in the peripheral edge surface of the mounting board.

20. The support rack of claim 18, further comprising:
a manual grip on the clamp, the manual grip being configured to enable a hand to grasp the manual grip and manually move the clamp and the mounting board together when the clamp is locked to the mounting board.
